(19) United States
(12) Patent Application Publication
(10) Pub. No.: US 2006/0121204 A1
(43) Pub. Date: Jun. 8, 2006

(54) Water-based intercoating composition and method of forming multilayered coating film

(76) Inventors: Yasukiho Nakae, Kyoto-shi, Kyoto (JP); Atsuo Magoshi, Osaka-shi, Osaka (JP); Tsuyoshi Imamura, katano-shi, Osaka (JP); Shoichi Takesako, Hirakata-shi, Osaka (JP); Daisuke Segawa, Ibaraki-shi, Osaka (JP)

Correspondence Address: FITCH, EVEN, TABIN & FLANNERY, P. O. BOX 65973, WASHINGTON, DC, 20035, US

(21) Appl. No.: 10/541,813

(22) PCT Filed: Feb. 3, 2005
(86) PCT No.: PCT/JP05/01585

§ 371 Date: Jul. 8, 2005

(30) Foreign Application Priority Data
Feb. 6, 2004 (JP) 2004-030297

(51) Int. Cl. B05D 1/36

(52) U.S. Cl. 427/402

(57) ABSTRACT

A water-based intermediate coating composition which contains a water-dispersible polyurethane composition is used. Here, the water-dispersible polyurethane composition is obtained from: a polyisocyanate component containing diisocyanate as an essential component; a polyol component containing polycarbonatediol with an average molecular weight of 500 to 5,000 and carboxyl group-containing diol as essential components; an amine component containing a monoamine compound as an essential component; a carboxyl group-neutralizing component; and water. A three-layered coating film including the water-based intermediate coating, a water-based base coating and a clear coating is formed through a wet-on-wet process on a material onto which an electrodeposited coating film is formed. Thereafter, the three coating films are baked and cured at the same time, thereby forming a multilayer coating film.

### TECHNICAL FIELD

The present invention relates to a water-based intermediate coating composition and a method of forming a multilayer coating film.

### BACKGROUND ART

In recent years, in view of global environmental problems and resource savings, water-based coatings that are friendly to the environment, in which an organic solvent is partly or wholly replaced by water, have come into use in a wide range, in coatings for industrial fields such as automobile coatings and for construction and building material fields.

If a conventional water-based coating is applied, for example, to automobile coatings, particularly to an intermediate coating, and more particularly to an intermediate coating formed through a three-wet technique (a coating method of baking at one time a three-layered coating film formed by a wet-on-wet method, which is also referred to as a three-coat one-bake method or 3C1B) that is required particularly for the purpose of energy savings recently, there arise the following problems: that, since anti-chipping property of a coating film is particularly weak, peeling occur at the interface between the intermediate coating film and an electrodeposited coating film which is a primer coating, and also at the interface between the intermediate coating film and a basecoat which is a top coating; and that the resulting coating film is inferior in appearance, in water resistance, in solvent resistance and in durability. In addition, there has been a problem that when spray guns are cleaned in coating lines, conventional water-based coatings attached to the spray guns are harder to be removed than solvent-based coatings. These problems have been hampering the shift from solvent-based coatings to water-based coatings.

Here, an intermediate coating formed through the three-wet technique will be described. In automobile body coatings, a multilayer coating film is formed. Specifically, cationic electrodeposition coating is firstly carried out on a steel plate which has been subjected to zinc phosphate treatment to form an electrodeposited coating film. An intermediate coating is then applied on the electrodeposited coating film to form an intermediate coating film. Abase coating for providing designs is applied on the intermediate coating film to form a base coating film. Finally, a clear coating is applied on the base coating film to form a clear top coating film. In this method of forming a multilayer coating film, conventionally, a baking and curing process is performed both after the formation of the intermediate coating film and after the formation of the clear top coating film. In the three-coat one-bake coating method, the baking and curing process performed after the formation of the intermediate coating film is omitted, and thereby the baking and curing process conventionally performed twice is performed once. Omission of the baking and curing process performed after the formation of the intermediate coating film provides substantial energy savings as well as reduces the time required for the coating process, resulting in cost reduction. On the other hand, in order not to incur reduction in physical properties of an intermediate coating film, it is required that coating performance of this method be maintained while ensuring qualities such as paint-removability.

For example, Japanese Patent Laid-Open Gazette No. Hei 08-33865 (Document 1) relates to a wet-on-wet coating method, wherein a thermosetting water-based coating (A) is coated, and a thermosetting water-based coating (B) is applied on the coated surface without curing the thermosetting water-based coating (A). Document 1 discloses that a neutralization value of the base resin of the water-based coating (A) is set to 10 to 40 mg KOH/g, that a neutralization value of the base resin of the water-based coating (B) is set to 10 to 20 mg KOH/g larger than that of the water-based coating (A), that the water-based coating (A) containes a crosslinking agent and base resin having a carboxyl group and a crosslinkable group, and that an acid value of the base resin of the water-base coating (A) ranges from 10 to 50 mg KOH/g.

Moreover, Japanese Patent Laid-Open Gazette No. 2001-205175 (Document 2) relates to a method of forming a coating film, wherein, by use of a water-based intermediate coating, by use of a water-based metallic base coating and by use of a clear coating, an intermediate coating film, a metallic base coating film and a clear coating film are sequentially formed on a material onto which an electrodeposited coating film is formed. Document 2 discloses that the water-based intermediate coating includes amide group-containing acrylic resin particles dispersed in water, which is obtained by emulsion polymerization of an amide group-containing ethylenically unsaturated monomer and another ethylenically unsaturated monomer, and that an acid value of the amide group-containing acrylic resin particles ranges from 0 to 100 mg KOH/g. Moreover, in Document 2, a carboxyl group-containing monomer, a hydroxyl group-containing monomer and a (meth)acrylate monomer are disclosed as an example for another ethylenically unsaturated monomer, and a polymerizable unsaturated monocarboxylate ester of polyalcohol is disclosed as a crosslinkable monomer.

In addition, Japanese Patent Laid-Open Gazette No. Hei 07-166093 (Document 3) reports an automobile coating with anti-chipping property, which is formed by use of a polyurethane emulsion and an acryl emulsion. Japanese Patent Laid-Open Gazette No. Hei 06-9925 (Document 4) reports a water-based coating with anti-chipping property, which is formed by use of copolymer resin and polyurethane, the copolymer resin including ethylene and an ethylenically unsaturated monomer having a carboxyl group as main components. Moreover, Japanese Patent Laid-Open Gazette No. 2000-119556 (Document 5) reports a water-based coating composition formed by use of a polymer having polysiloxy groups, a copolymer resin which includes an ethylenically unsaturated monomer and an ethylenically unsaturated monomer with a carboxyl group as main components, and a water-base polyurethane.

However, the techniques that are described in the above documents can not provide a water-based intermediate coating which can achieve the following features at the same time: enhanced paint-removability of spray guns and the like; excellent anti-chipping property when formed into a multilayer coating; and excellent appearance.

### DISCLOSURE OF THE INVENTION

It is an object of the present invention to provide a water-based intermediate coating composition which has excellent paint-removability of spray guns and the like, excellent anti-chipping property when formed into a multilayer coating, and excellent appearance, and a method of forming a multilayer coating film using this water-based intermediate coating composition.

The water-based intermediate coating composition of the present invention is characterized by containing a water-dispersible polyurethane composition (A) which can be obtained by use of: a polyisocyanate component (a1) containining diisocyanate as an essential component; a polyol component (a2) containing polycarbonatediol having an average molecular weight of 500 to 5,000 and having carboxyl group-containing diol as essential components; an amine component (a3) including a monoamine compound as an essential component; a carboxyl group-neutralizing component (a4); and water (a5).

In the water-based intermediate coating composition of the present invention, the polyisocyanate component (a1) may further include polyisocyanate other than the diisocyanate as an arbitrary component, the polyol component (a2) may further include polyol other than the polycarbonatediol and the carboxyl group-containing diol as an arbitrary component, and the amine component (a3) may further include a diamine compound as an arbitrary component.

Moreover, the water-based intermediate coating composition of the present invention can further includes a water-dispersible acrylic resin (B) and a curing agent (C) together with the above-described water-dispersible polyurethane composition (A). Here, the water-dispersible acrylic resin (B) can be prepared as follows: at least one monomer (b1) selected from (meth)acrylic acid alkyl esters, an acid group-containing polymerizable unsaturated monomer (b2), a hydroxyl group-containing polymerizable unsaturated monomer (b3) and a crosslinkable monomer (b4) are mixed; the resultant monomer mixture, which has a glass transition temperature of −50° C. to 20° C., an acid value ranging from 2 to 60 mg KOH/g and a hydroxyl group value ranging from 10 to 120 mg KOH/g, is subjected to emulsion polymerization.

In this case, the monomer (b1) may further include at least one monomer selected from the group consisting of styrene-based monomers, (meth)acrylonitrile and (meth)acrylamide.

The solid contents of the water-dispersible polyurethane composition (A), of the water-dispersible acrylic resin (B) and of the curing agent (C) preferably account for 5 to 35% by weight, 15 to 90% by weight and 5 to 50% by weight, respectively, of the total resin solid contents of the water-dispersible polyurethane composition (A), the water-dispersible acrylic resin (B) and the curing agent (C).

With respect to the above-described water-dispersible polyurethane composition (A), the sum of the number of moles of hydroxyl groups in the polyol component (a2) and the number of moles of amino groups in the amine component (a3) is preferably 0.50 to 2.0 times the number of moles of isocyanate groups in the polyisocyanate component (a1). Moreover, it is preferable that the amine component (a3) of the above-described water-dispersible polyurethane composition (A) includes a monoamine compound and a diamine compound, and a diamine compound contained in the amine component (a3) of the above-described water-dispersible polyurethane composition (A) can make up 5 to 99 mol % of the total amount of the amine component (a3). As a preferable monoamine compound contained in the amine component (a3) of the above-described water-dispersible polyurethane composition A, an alkanolamine can be cited.

The crosslinkable monomer component (b4) of the above-described water-dispersible acrylic resin (B) may be at least one crosslinkable monomer selected from the group consisting of carbonyl group-containing polymerizable unsaturated monomers, hydrolysis polymerizable silyl group-containing monomers and multifunctional vinyl monomers. As the crosslinkable monomer component (b4) of the above-described water-dispersible acrylic resin (B), at least a carbonyl group-containing polymerizable unsaturated monomer is preferably contained. In addition, as a crosslinking aid, a hydrazine compound is preferably contained. Moreover, 0.5 to 10 weight parts of the crosslinkable monomer component (b4) of the above-described water-dispersible acrylic resin (B) can be used for 100 weight parts of the total weight of the other monomer components (b1), (b2) and (b3).

It is preferable that the above-described curing agent (C) be at least one curing agent selected from the group consisting of melamine resin, isocyanate resin, oxazoline-based compounds and carbodiimide-based compounds.

The water-based intermediate coating composition of the present invention may further include a curing agent-contained emulsion (D). Here, the curing agent-contained emulsion (D) can be prepared as follows: a polymerizable unsaturated monomer (d1), an acid group-containing polymerizable unsaturated monomer (d2) and a hydroxyl group-containing polymerizable monomer (d3) are mixed; the resultant monomer mixture, which has a glass transition temperature of −30° C. to 30° C., an acid value ranging from 5 to 15 mg KOH/g and a hydroxyl group value ranging from 30 to 100 mg KOH/g, is subjected to emulsion polymerization under the presence of a curing agent (C′). It is preferable that the curing agent (C′) be at least one selected from the group consisting of melamine resin, isocyanate resin, oxazline-based compounds and carbodiimide-based compounds. As the preferable example for the curing agent (C′), melamine resin having a methoxy group and a butoxy group can be cited, wherein the methoxy/butoxy ratio is in a range of 70/30 to 0/100 and water-compatibility thereof is 10 ml/g or less.

The above-described curing agent-contained emulsion (D) is preferably obtained by further mixing a polymerizable monomer (d4), having at least two radically polymerizable unsaturated groups in the molecule, with the monomers (d1) to (d3), so that the polymerizable monomer (d4) constitutes 1 to 15% by weight of the total weight of monomers (d1) to (d4), and by subjecting the resultant mixture to emulsion polymerization.

The method of forming a multilayer coating film according to the present invention is characterized in that: any of the above-described water-based intermediate coating compositions of the present invention is applied to a material onto which an electrodeposited coating film is formed; a water-based base coating and a clear coating are sequentially applied on the material through a wet-on-wet process without curing this water-based intermediate coating; thereafter, the intermediate coating, the water-based base coating and the clear coating are baked and cured at the same time; and thereby the multilayer coating film, which includes the intermediate coating film, the base coating film and the clear coating film, is formed.

The water-based intermediate coating composition of the present invention contains a specific water-dispersible polyurethane composition. The water-based intermediate coating composition including this water-dispersible polyurethane composition and the internally crosslinked water-dispersible acrylic resin makes it possible to enhance anti-chipping property of a multilayer coating film to be formed and to provide fine appearance of the coating film, while maintaining excellent paint-removability of spray guns in a coating process, of paint tanks and of paint sending pipes, or excellent removability of a coating unintentionally attached.

Furthermore, the further addition of a curing agent-contained emulsion enhances paint-removability of the spay guns and the like, anti-chipping property, and the recoat adhesion property is also increased.

In a case where the method of forming a multilayer coating film is employed, where the water-based intermediate coating composition and the three-coat one-bake method of the present invention are used, it is possible to form a multilayer coating film that is excellent in anti-chipping property and finish appearance.

### BEST MODE FOR CARRYING OUT THE INVENTION

Hereinafter, the present invention will be described in detail.

A water-dispersible polyurethane composition (A) used in a water-based intermediate coating composition of the present invention is prepared from the following components (a1) to (a5):

(a1) a polyisocyanate component containing diisocyanate as an essential component and another polyisocyanate as an arbitrary component;

(a2) a polyol component containing polycarbonatediol with an average molecular weight of 500 to 5,000 and carboxyl group-containing diol as essential components, and containing another polyol as an arbitrary component;

(a3) an amine component containing a monoamine compound as an essential component and a diamine compound as an arbitrary component;

(a4) a carboxyl group-neutralizing component; and

(a5) water.

The diisocyanate, which is the essential component of the polyisocyanate component (a1), is not particularly limited and well known diisocyanates can be used either alone or in combination of two or more. Examples of diisocyanates include: aromatic diisocyanates such as tolylene diisocyanate, diphenylmethane-4,4′-diisocyanate, p-phenylene diisocyanate, xylylene diisocyanate, 1,5-naphtylene diisocyanate, 3,3′-dimethyldiphenyl-4,4′-diisocyanate, dianisidine diisocyanate and tetramethylxylylene diisocyanate; alicyclic diisocyanates such as isophorone diisocyanate, dicyclohexylmethane-4,4′-diisocyanate, trans-1,4-cyclohexyl diisocyanate, norbornane diisocyanate; and aliphatic diisocyanates such as 1,6-hexamethylene diisocyanate, (2,2,4)-and/or (2,4,4)-trimethylhexamethylene diisocyanate and lysine diisocyanate. Alicyclic diisocyanates are preferable because resultant polyurethane molecules and a coating film produced therefrom exhibit excellent anti-hydrolysis property. Among them, isophorone diisocyanate and dicyclohexylmethane-4,4′-diisocyanate are more preferable.

The above-described diisocyanates may be used in a modified form such as carbodiimide modification, isocyanurate modification and biuret modification, and may be used in a form of blocked isocyanate blocked by means of various blocking agents. If the content (% by weight) of the diisocyanate in the polyisocyanate component (a1) is less than 50%, there is a possibility that compatibility of diisocyante with other components of the intermediate coating is reduced. Accordingly, the content thereof is preferably 50% or more, more preferably 70% or more.

Another polyisocyanate compound, which is the arbitrary component of the polyisocyanate component (a1) according to the present invention, means polyisocyanate including three or more isocyanate groups in one molecule. For example, isocyanurate trimer, biuret trimer, and trimethylolpropane adduct of the above-exemplified diisocyanates; and isocyanates having three or more functional groups, such as triphenylmethane triisocyanate, 1-methylbenzole-2,4,6-triisocyanate and dimethyltriphenylmethane tetraisocyanate can be cited. These isocyanate compounds may be used in a modified form of carbodiimide modification, isocyanurate modification and biuret modification, and may be used in a form of blocked isocyanate blocked by means of various blocking agents.

In the polyol component (a2) according to the present invention, the polycarbonatediol, the essential component, has an average molecular weight of 500 to 5,000. If the average molecular weight is less than 500, the adhesion property of a coating film to an undercoating is decreased. If the average molecular weight is greater than 5,000, dispersion stability of water-dispersible polyurethane and impact resistance of a coating film are insufficient. Meanwhile, diol that is used as raw material for the production of polycarbonatediol is not particularly limited, and low molecular weight diols, such as ethylene glycol, 1,2-propanediol, 1,3-propanediol, 2-methyl-1,3-propanediol, 2-butyl-2-ethyl-1,3-propanediol, 1,4-butanediol, neopentyl glycol, 3-methyl-2,4-pentanediol, 2,4-pentanediol, 1,5-pentanediol, 3-methyl-1,5-pentanediol, 2-methyl-2,4-pentanediol, 2,4-diethyl-1,5-pentanediol and 1,6-hexanediol can be arbitrarily selected. Among them, 1,6-hexanediol is preferable because it is available at low cost.

In the polyol component (a2), the carboxyl group-containing diol, the essential component, serves to introduce hydrophilic groups into polyurethane molecules. The hydrophilic group is a neutralized carboxyl group. Specific examples include dimethylol propionic acid, dimethylol butanoic acid, dimethylol butyric acid and dimethylol valeric acid.

Meanwhile, another polyol compound which is the arbitrary component of the polyol component (a2) is not particularly limited, and well known polyols may be used alone or in combination of two or more. Examples of the polyols include low molecular weight polyol, polyether polyol, polybutadiene polyol, silicone polyol and polyol having ester bonds.

Examples of the above-described low molecular polyols include aliphatic diols such as ethylene glycol, 1,2-propanediol, 1,3-propanediol, 2-methyl-1,3-propanediol, 2-butyl-2-ethyl-1,3-propanediol, 1,4-butanediol, neopentyl glycol, 3-methyl-2,4-pentanediol, 2,4-pentanediol, 1,5-pentanediol, 3-methyl-1,5-pentanediol, 2-methyl-2,4-pentanediol, 2,4-diethyl-1,5-pentanediol, 1,6-hexanediol, 1,7-heptanediol, 3,5-heptanediol, 1,8-octanediol, 2-metyl-1,8-octanediol, 1,9-nonanediol, 1,10-decanediol, diethylene glycol and triethylene glycol; alicyclic diols such as cyclohexanedimethanol and cyclohexanediol; and polyalcohols such as trimethylolethane, trimethylol propane, hexitols, pentytols, glycerin, pentaerythritol and tetramethylolpropane.

Examples of polyeterpolyols include ethylene oxide and/or propylene oxide adduct of the above-described low molecular polyols and polytetramethyleneglycol.

Examples of the silicone polyol include silicone oils having siloxane bonds in a molecule, the terminals of which are hydroxyl groups.

Examples of polyols having ester bonds include polyesterpolyol and polyesterpolycarbonatepolyol.

Examples of the above-described polyesterpolyol include polyesterpolyols obtained by direct esterification reaction and/or trans-esterification reaction of the above-exemplified low molecular polyalcohols and a polycarboxylic acid, the quantity of which is less than the stoichiometric quantities of the polyalcohols, or an ester-forming derivatives. Here, examples of the ester-forming derivatives include esters, anhydrides and halides of the polycarboxylic acid. For the polycarbonic acid or ester-forming derivate thereof, citable examples include: aliphatic dicarboxylic acid such as oxalic acid, malonic acid, succinic acid, glutaric acid, adipic acid, pimelic acid, suberic acid, azelaic acid, sebacic acid, dodecanedioic acid, 2-methylsuccinic acid, 2-methyladipic acid, 3-methyladipic acid, 3-methylpentanedioic acid, 2-methyloctanedioic acid, 3,8-dimethyldecanedioic acid, 3,7-dimethyldecanedioic acid, hydrogenated dimer acid and dimer acid; aromatic dicarboxylic acid such as phthalic acid, terephthalic acid, isophthalic acid and naphthalenedicarboxylic acid; alicyclic dicarboxylic acid such as 1,2-cyclopentanedicarboxylic acid, 1,3-cyclopentanedicarboxylic acid, 1,2-cyclohexanedicarboxylic acid, 1,3-cyclohexanedicarboxylic acid, 1,4-cyclohexanedicarboxylic acid 1,4-dicarboxylmethylenecyclohexane, nasic acid and methylnasic acid; polycarboxylic acid such as tricarboxylic acid including trimelltic acid, trimesic acid and trimer of castor oil fatty acid, acid anhydride of the polycarboxylic acid; halide such as chloride of the polycarboxylic acid and bromide of the polycarboxylic acid; lower ester such as methyl ester, ethyl ester, propyl ester, isopropyl ester, butyl ester, isobutyl ester and amyl ester of the polycarboxylic acid; and lactones such as γ-caprolactone, δ-caprolactone, ε-caprolactone, dimethyl-ε-caprolactone, δ-valerolactone, γ-valerolactone and γ-butyllactone can be cited.

With respect to the relative proportion of the polyol component (a2) according to the present invention, if the content of polycarbonatediol having an average molecular weight of 500 to 5,000 is less than 50% by weight, it may cause reduction in strength. If it exceeds 97% by weight, it is likely that water dispersion property of the resultant polyurethane is reduced. Therefore, it is preferable that the content be in a range of 50 to 97% by weight, more preferably in a range of 75 to 95% by weight. Meanwhile, if the content of carboxyl group-containing diol is less than 3% by weight, it is likely that sufficient water dispersion property cannot be obtained. In addition, if it exceeds 30% by weight, strength and water resistance of the resultant coating film may be reduced. Therefore, it is preferable that the content of carboxyl group containing diol be in a range of 3 to 30% by weight, more preferably in a range of 5 to 25% by weight.

With respect to the amine component (a3) according to the present invention, the monoamine compound, the essential component, is not particularly limited, and well known monoamine compounds may be used either alone or in combination of two or more. Examples of the monoamine compounds include: alkyl amines such as ethylamine, propyl amine, 2-propylamine, butylamine, 2-butylamine, tert-butylamine and isobutylamine; aromatic amines such as aniline, methylaniline, phenylnaphthylamine and naphthylamine; alicyclic amines such as cyclohexaneamine and methylcyclohexaneamine; etheramines such as 2-methoxyethylamine, 3-methoxypropylamine and 2-(2-methoxyethoxy)ethylamine; and alkanolamines such as ethanolamine, propanolamine, butylethanolamine, 1-amino-2-methyl-2-propanol, 2-amino-2-methylpropanol, diethanolamine, diisopropanolamine, dimethylaminopropylethanolamine, dipropanolamine, N-methylethanolamine and N-ethylethanolamine. Among them, alkanolamines are preferable because they impart excellent water dispersion stability to polyurethane molecules, and 2-aminoethanol and diethanolamine are more preferable because they are low in cost.

With respect to the amine component (a3) according to the present invention, the diamine compound, the arbitrary component, is not particularly limited, and well-known diamine compounds may be used either alone or in combination of two or more. Examples of the diamine compounds include: low molecular diamines obtained by substituting alcoholic hydroxyl groups in the above-illustrated low molecular diols with amino groups, such as ethylenediamine and propylenediamine; polyetherdiamines such as polyoxypropylenediamine and polyoxyethylenediamine; alicyclic diamines such as menthendiamine, isophoronediamine, norbornanediamine, bis(4-amino-3-methyldicyclohexyl)methane, diaminodicyclohexylmethane, bis(aminomethyl)cyclohexane, 3,9-bis(3-aminopropyl)2,4,8,10-tetraoxaspiro(5,5)undecane; aromatic diamines such as m-xylenediamine, α-(m/p aminophenyl)ethylamine, m-phenylenediamine, diaminodiphenylmethane, diaminodiphenylsulfone, diaminodiethyldimethyldiphenylmethane, diaminodiethyldiphenylmethane, dimethylthiotoluenediamine, diethyltoluenediamine and α,-α-bis(4-aminophenyl)-p-diisopropylbenzene; hydrazine; and dicarboxylic acid dihydrazide compounds formed from hydrazine and the dicarboxylic acids illustrated in the above-described polycarboxylic acids used for polyesterpolyols. Among these diamine compounds, low molecular weight diamines are preferable because they are low in cost, and ethlenediamine is more preferable.

With respect to the relative portion of the amine component (a3) according to the present invention, if the content of the diamine compound, the arbitrary component, is less than 5 mol %, it is likely that sufficient coating film strength can not be obtained. If it exceeds 95 mol %, the molecular weight of polyurethane becomes large and may cause reduction in water dispersion stability. Therefore, it is preferable that the content of the diamine compound be in a range of 5 to 95 mol %, more preferably in a range of 5 to 50 mol %.

Neutralizers used in the carboxyl group-neutralizing component (a4) according to the present invention are basic compounds that react with carboxyl groups in the above-described carboxyl group-containing diols to form hydrophilic salts. For example, tertiary amines such as trialkylamines (such as trimethylamine, triethylamine and tributylamine), N,N-dialkylalkanolamines (such as N,N-dimethylethanolamine, N,N-dimethylpropanolamine, N,N-dipropylethanolamine and 1-dimethylamino-2-methyl-2-propanol), N-alkyl-N,N-dialkanolamines, and trialkanolamines (such as triethanolamine); ammonia; trimethylammoniumhydroxide; sodium hydroxide; potassium hydroxide; and lithium hydroxide. Among these compounds, tertiary amine compounds are preferable because excellent water dispersion property can be provided for the resultant water-dispersible polyurethane composition (A).

In addition to the above-described components (a1) to (a5), internal-branching agents and internal-crosslinking agents may be used for the water-dispersible polyurethane composition (A). These agents serve to provide polyurethane molecules with branches and crosslinked structures. Examples of the internal-branching agent and internal-crosslinking agent include melamine and methylolmelamine.

The method of preparing the water-dispersible polyurethane composition (A) is not particularly limited, and well known methods can be adopted. The following preparation method is preferable. That is, pre-polymer or polymer is prepared in an inert solvent which has a high compatibility with water; and water is fed thereto for dispersion. Example of such a method includes: (I) preparing pre-polymer from the polyisocyanate component (a1) and the polyol component (a2), and allowing the pre-polymer to react with the amine component (a3) in water; and (II) preparing polymer from the polyisocyanate component (a1), the polyol component (a2) and the amine component (a3), and feeding the polymer into water to cause the polymer to disperse in water. Moreover, the neutralizer component may be previously added to water into which pre-polymer or polymer is to be fed, or may be added after feeding.

Among the above-described preparation methods, the method (I) is preferable because it is easier to control composition and reaction to provide excellent dispersion property.

Examples of the inert solvents having a high compatibility with water, which is used in the above-described suitable preparation method, include acetone, methylethylketone, dioxane, tetrahydrofuran and N-metyl-2-pyrrolidone. Generally, the amount of the solvent used is 3 to 100% by weight of the total amount of the above-described materials used for preparing the pre-polymer.

In the above-described preparation method, the mixing ratio is not particularly limited. The mixing ratio is replaced by the molar ratio between the isocyanate groups of the polyisocyanate component (a1) and the isocyanate-reactive groups of the polyol component (a2) and the amine component (a3) in a reaction stage. The molar ratio of isocyanate groups to isocyanate-reactive group is preferably in a range of 1:0.5 to 1:2.0. This is attributed to the facts that shortage of unreacted isocyanate groups in dispersed polyurethane molecules may cause reduction in adherence property and strength of a coating film when the polyurethane is used for a coating and that excessive amount of unreacted isocyanate groups may influence dispersion stability and physical properties of a coating. Further, the molar ratio of isocyanate-reactive group in the polyol component (a2) to isocyanate group in the polyisocyanate component (a1) is preferably in a range of 0.3:1 to 1.0:1, more preferably in a range of 0.5:1 to 0.9:1. Furthermore, the molar ratio of isocyanate-reactive group in the amine component (a3) to isocyanate group in the polyisocyanate component (a1) is preferably in a range of 0.1:1 to 1.0:1, more preferably in a range of 0.2:1 to 0.5:1.

The rate of neutralization is caused by the carboxyl group-neutralizing component (a4) is set so as to provide sufficient dispersion stability with the resultant water-dispersible polyurethane composition (A). For one mole of the carboxyl groups in the polyol component (a2), the carboxyl group-neutralizing component (a4) is preferably 0.5 to 2.0 times equivalent weight, more preferably 0.7 to 1.5 times equivalent weight.

For the states of the water-dispersible polyurethane composition (A), emulsion, suspension, colloidal dispersion, aqueous solution and the like can be cited. In order to achieve stable dispersion property, one or more emulsifiers, such as a surfactants, may be used. The particle size is not particularly limited in a case where particles are in the state of emulsion, suspension or colloidal dispersion, where particles are dispersed in water. However, the particle size is preferably 1 μm or less, more preferably 500 nm or less to maintain excellent dispersion state.

Examples of the above-described emulsifiers include an anionic surfactant, a nonionic surfactant, a cationic surfactant, an amphoteric surfactant, a high molecular surfactant and a reactive surfactant, which are well known and used in water-dispersible polyurethane. When these agents are to be used, an anionic surfactant, a nonionic surfactant or a cationic surfactant is preferable because they are low in cost and can provide excellent emulsification.

Examples of the above-described anionic surfactants include: alkyl sulfates such as sodium dodecyl sulfate, potassium dodecyl sulfate and ammonium dodecyl sulfate; sodium dodecyl polyglycol ether sulfate; sodium sulfo ricinolate; alkyl sulfonates such as alkali-metal salt of paraffin sulfonate and ammonium salt of paraffin sulfonate; fatty acid salts such as sodium laurate, triethanolamine olate and triethanolamine abietate; alkylaryl sulfonates such as sodium benzene sulfonate and alkali-metal sulfate of alkali phenol hydroxyethylene; higher alkyl naphthalene sulforate; naphthalenesulfonic acid-formalin condensate; dialkylsulfosuccinate; polyoxyethylenealkylsulfate; and polyoxyethylenealkylarylsulfate.

Examples of the above-described nonionic surfactants include ethyleneoxide and/or propyleneoxide adduct of an alcohol having 1 to 18 carbon atoms, ethyleneoxide and/or propyleneoxide adduct of an alkylphenol, and ethyleneoxide and/or propyleneoxide adduct of an alkylene glycol and/or an alkylene diamine.

Examples of the alcohols having 1 to 18 carbon atoms, which constitute the above-described nonionic surfactants, include methanol, ethanol, propanol, 2-propanol, butanol, 2-butanol, tert-butanol, amyl alcohol, isoamyl alcohol, tert-amyl alcohol, hexanol, octanol, decanol, lauryl alcohol, myristyl alcohol, palmityl alcohol and stearyl alcohol. Examples of alkylphenol include phenol, methylphenol, 2,4-di-tert-butylphenol, 2,5-di-tert-butylphenol, 3,5-di-tert-butylphenol, 4-(1,3-tetramethylbutyl)phenol, 4-isooctylphenol, 4-nonylphenol, 4-tert-octylphenol, 4-dodecylphenol, 2-(3,5-dimethylheptyl)phenol, 4-(3,5-dimethylheptyl)phenol, naphthol, bisphenol A and bisphenol F. Examples of alkylene glycol include ethylene glycol, 1,2-propanediol, 1,3-propanediol, 2-methyl-1,3-propanediol, 2-butyl-2-ethyl-1,3-propanediol 1,4-butanediol, neopentyl glycol, 1,5-pentanediol, 3-methyl-1,5-pentanediol, 2,4-diethyl-1,5-pentanediol and 1,6-hexanediol. Examples of alkylenediamines include diamines obtained by substituting alcoholic hydroxyl groups of these alkylene glycols with amino groups. In addition, the ethylene oxide and/or propylene oxide adduct may be either random or block adduct.

Examples of the above-described cationic surfactants include primary, secondary and tertiary amine salts, pyridinium salt, alkylpyridinium salt, and quaternary ammonium salts such as alkyl halide quaternary ammonium salts.

When these emulsifiers are used, the amount thereof is not particularly limited and can be arbitrary. However, if the amount (in terms of the mass ratio of the emulsifier to one polyurethane compound) is less than 0.05, it is likely that sufficient dispersion property cannot be obtained. Meanwhile, if the amount exceeds 0.3, it is likely that water resistance, strength, extension and the like of a coating film obtained by a water-based intermediate coating may be reduced. Accordingly, it is preferable that the amount be in a range of 0.01 to 0.3, more preferably in a range of 0.05 to 0.2.

In addition, in the water-dispersible polyurethane composition (A), the solid content thereof is not particularly limited, and an arbitrary value can be selected. The solid content is preferably in a range of 10 to 70% by weight, more preferably in a range of 20 to 60% by weight to provide excellent dispersion and coating property.

An average molecular weight of the polyurethane which is dispersed in the water-dispersible polyurethane composition (A) is not particularly limited, and is selected in a manner that excellent dispersion property as a water-based coating and an excellent coating film can be obtained. The average molecular weight preferably ranges from 5,000 to 200,000, more preferably ranges from 10,000 to 50,000. If the average molecular weight is in a range of 5,000 to 200,000, attached coatings can be easily removed when being cleaned. In addition, the hydroxyl group value (OH Value) is not particularly limited, and can be arbitrarily selected. The hydroxyl group value is represented by consumption amount (mg) of KOH per 1 g of resin, and is generally 0 to 100.

Moreover, with respect to physical properties of the water-dispersible polyurethane composition (A), preferable physical properties are what provide more excellent anti-chipping property. With an impact-buffering effect and energy propagation taken into consideration, a balance between elongation and tensile strength is critical in order to provide excellent anti-chipping property. In a water-dispersible polyurethane composition which has low tensile strength and high elongation, flaws due to chipping tends to enlarge. In a water-dispersible polyurethane composition which has high tensile strength and low elongation, flaws due to chipping tends to deepen. Polyurethane compositions can provide excellent anti-chipping property if the following conditions are satisfied: that the tensile strength is 10 to 100 MPa; that the elongation percentage is 100 to 1,000%; and that the tensile strength (Mps)/elongation percentage (%) value is in a range of 0.01 to 0.5. These conditions are set in accordance with the tensile test of a test specimen under the followng conditions: that temperature is 25° C.; that test speed is 500 mm/min; and that span interval is 40 mm. Here, the test specimen is obtained by drying a polyurethane composition at 25° C. for 12 hours, and then by subjecting the polyurethane composition to heat curing at 120° C. for 1 hour to be molded into a 150 μm thickness dumbbel-shaped test specimen No. 2.

The water-dispersible acrylic resin (B) used in the water-based intermediate coating composition of the present invention is prepared from the following monomers (b1) to (b4):

(b1) monomers containing at least one monomer selected from (meth) acrylic acid alkyl esters and, when needed, at least one monomer selected from the group consisting of styrene-based monomers, (meth)acrylonitrile and (meth)acrylamide;

(b2) acid group-containing polymerizable unsaturated monomers;

(b3) hydroxyl group-containing polymerizable unsaturated monomers; and

(b4) crosslinkable monomers.

Hereinafter, monomer components (b1), (b2), (b3) and (b4) of the water-dispersible acrylic resin (B) will be described. It is to be noted that an “acrylic” polymerizable unsaturated monomer and a “methacrylic” polymerizable unsaturated monomer are collectively referred to as a “(meth)acrylic” monomer herein.

The monomer component (b1) is a polymerizable unsaturated monomer which contains neither an acid group nor a hydroxyl group and contains (meth)acrylic acid alkyl ester as an essential component. Preferable (Meth) acrylic acid alkyl esters include alkyl groups having 1 to 18 carbon atoms. Specific examples include methyl (meth)acrylate, ethyl (meth)acrylate, propyl (meth)acrylate, n-butyl (meth)acrylate, isobutyl (meth)acrylate, t-butyl (meth)acrylate, hexyl (meth)acrylate, 2-ethylhexyl (meth)acrylate, octyl (meth)acrylate, nonyl (meth)acrylate, decyl (meth)acrylate, dodecyl (meth)acrylate and stearyl (meth)acrylate. These compounds can be appropriately used either alone or in combination of two or more.

The monomer component (b1) may contain at least one monomer selected from the group consisting of styrene-based monomers, (meth)acrylonitrile and (meth)acrylamide, as an arbitrary component. In addition to styrene, α-methylstyrene and the like can be cited as a styrene-based monomer. These monomers can be appropriately used alone or in combination of two or more.

The acid group-containing polymerizable unsaturated monomers (b2) are ethylenically unsaturated compounds having at least one acid group in a molecule. The acid group is selected from, for example, carboxyl group, sulfonic group and phosphate group. For the carboxyl group-containing polymerizable unsaturated monomers among the acid group-containing polymerizable unsaturated monomers (b2), for example, acrylic acid, methacrylic acid, crotonic acid, isocrotonic acid, propylacrylic acid, isopropylacrylic acid, itaconic acid, maleic anhydride, fumaric acid and the like can be cited. Examples of the sulfonic group-containing polymerizable unsaturated monomers include p-vinylbenzenesulfonic acid, p-acrylamidepropanesulfonic acid and t-butylacrylamidesulfonic acid. Examples of the phosphoric acid group-containing polymerizable unsaturated monomers include Light Ester PM (manufactured by Kyoeisha Chemical Co., Ltd.) such as phosphoric acid monoester of 2-hydroxyethyl acrylate, and phosphoric acid monoester of 2-hydroxypropyl methacrylate. These compounds are appropriately used alone or in combination or two or more.

The acid group-containing polymerizable unsaturated monomer increase storage stability, mechanical stability and stability against freezing of the resultant water-dispersible acrylic resin (B) and also serve as a curing reaction-accelerating catalyst in a case where melamine resin or the like is combined with a curing agent in a coating film formation process. In consideration of increased stabilities and performance of the curing reaction-accelerating agent, it is important to use a carboxyl group-containing monomer for the monomers (b2). It is preferable that the carboxyl group-containing monomers make up 50% by weight or more of the monomers (b2).

Examples of hydroxyl group-containing polymerizable unsaturated monomers (b3) include 2-hydroxyethyl (meth)acrylate, 2-hydroxypropyl (meth)acrylate, 4-hydroxybutyl (meth) acrylate, N-methylolacrylamide, allyl alcohol and an ε-caprolactone-modified acrylic monomer. These compounds are appropriately used alone or in combination of two or more.

Examples of the ε-caprolactone-modified acrylic monomer include “Placcel FA-1”, “Placcel FA-2”, “Placcel FA-3”, “Placcel FA4”, “Placcel FA-5”, “Placcel FM-1”, “Placcel FM-2”, “Placcel FM-3”, “Placcel FM4” and “Placcel FM-5” (manufactured by Daicel Chemical Industries, Ltd).

The hydroxyl group-containing polymerizable unsaturated monomers (b3) provide hydrophilicity ascribable to hydroxyl groups with resin by copolymerization, thereby enhancing workability and stability against freezing when the resultant resin emulsion is used as a coating, and further provides curing reaction with melamine resin or isocyanate-based curing agents.

For the crosslinkable monomers (b4), a carbonyl group-containing polymerizable unsaturated monomer, a hydrolysis polymerizable silyl group-containing monomer and various polyfunctional vinyl monomers can be used. Examples of the carbonyl group-containing monomers include a monomer containing a keto group, such as acrolein, diacetone(meth)acrylamide, acetoacetoxyethyl (meth)acrylate, formylstyrol and alkyl vinyl ketone having 4 to 7 carbon atoms (e.g. methyl vinyl ketone, ethyl vinyl ketone, butyl vinyl ketone). Among them, diacetone (meth) acrylamide is preferable.

When such a carbonyl group-containing monomer is used, a hydrazine-based compound as a cross-linking aid is added to the water-dispersible acrylic resin (B) so that a crosslinked structure is formed when a coating film is formed. Examples of the hydrazine-based compounds include: saturated aliphatic carboxylic acid dihydrazides having 2 to 18 carbon atoms, such as oxalic acid dihydrazide, malonic acid dihydrazide, glutaric acid dihydrazide, succinic acid dihydrazide, adipic acid dihydrazide and sebacic acid dihydrazide; monoolefinic unsaturated dicarboxylic acid dihydrazide such as maleic acid dihydrazide, fumaric acid dihydrazide and itaconic acid dihydrazide; phthalic acid dihydrazide, terephthalic acid dihydrizide, isophthalic acid dihydrazide, pyromellitic acid dihydrazide, pyromellitic acid trihydrazide, pyromellitic acid tetrahydrazide; nitrilotrihydrazide, citric acid trihydrazide, 1,2,4-benzenetrihydrazide, ethylenediaminetetraacetic acid tetrahydrazide, 1,4,5,8-naphthoic acid tetrahydrazide; polyhydrazide obtained by allowing a low-molecular polymer having a carboxylic acid lower alkyl ester group to react with hydrazine or hydrazine hydrate; carbonic acid dihydrazide, bissemicarbazide; and aqueous polyfunctional semicarbazide obtained by allowing a hydrazine compound or above-exemplified dihydrazide to exceessively react with diisocyanate such as hexamethylene diisocyanate and isophorone diisocyanate, or with a polyisocyanate compound derived therefrom.

Examples of the hydrolysis polymerizable silyl group-containing monomers include a monomer having an alkoxysilyl group, such as γ-(meth) acryloxypropylmethyldimethoxysilane, γ-(meth)acryloxypropylmethyldiethoxysilane and γ-(meth)acryloxypropyltriethoxysilane.

The polyfunctional vinyl-based monomer is a compound having two or more radical-polymerizable ethylenically unsaturated groups in a molecule. For example, a divinyl compound such as divinylbenzene, ethylene glycol di(meth)acrylate, hexanediol di(meth)acrylate, polyethylene glycol di(meth)acrylate, allyl (meth)acrylate, 1,4-butanediol di(meth)acrylate, 1,6-hexane di(meth)acrylate, neopentyl glycol di(meth)acrylate, pentaerythritol di(meth)acrylate and the like are cited. In addition, triallyl cyanurate, pentaerythritol tri(meth)acrylate, trimethylolpropane tri(meth)acrylate, and dipentaerythritol hexa(meth)acrylate and the like can also be cited.

These compounds are appropriately used alone or in combination of two or more when they are used as the crosslinkable monomers (b4). The monomers (b4) are copolymerized, and thus the resultant water-dispersible acrylic resin (B) is imparted with self-crosslinkability.

The type and mixing ratio of the monomer components (b1), (b2), (b3) and (b4) are selected so that the mixture thereof shows a glass transition temperature of −50° C. to 20° C., an acid value of 2 to 60 mg KOH/g, and a hydroxyl group value of 10 to 120 mg KOH/g. Subsequently, the selected monomers are subjected to emulsion polymerization. Thus, the water-dispersible acrylic resin (B) of the present invention is produced.

The mixture of the monomer components should have a glass transition temperature (Tg) ranging from −50° C. to 20° C. By causing Tg of the mixture to satisfy this range, when a water-based intermediate coating containing the water-dispersible acrylic resin (B) is used in a wet-on-wet method, affinity and adhesion between an electrodeposited coating and the intermediate coating and between a top coating and the intermediate coating are improved. Thus, adaptability is enhanced at the interface between the top coating film and the intermediate coating film in a wet state, and therefore inversion does not occur. In addition, the final coating film has suitable softness, and anti-chipping property is enhanced. As a result, a multilayer coating film can be formed which has very good appearance. When Tg is lower than −50° C., mechanical strength of a coating film is insufficient, and anti-chipping property is reduced. On the other hand, when Tg is higher than 20° C., anti-impact resistance is deficient and anti-chipping property is reduced because a coating film becomes hard and brittle. Accordingly, Tg is in a range of −50° C. to 20° C., more preferably in a range of −40° C. to 10° C.

The mixture of the monomer components should have an acid value ranging from 2 to 60 mg KOH/g. By causing the acid value of the mixture to satisfy this range, stability in various aspects, such as storage stability, mechanical stability, and stability against freezing of a resin emulsion and a water-based intermediate coating composition using this resin emulsion are improved, and sufficient curing reaction is provided at formation of a coating film. Thus, a coating film can be improved in strength in various aspects, anti-chipping property and water resistance. When the acid value of the mixture is less than 2 mg KOH/g, stability in the above aspects becomes inferior, and sufficient curing reaction does not occur. Accordingly, the strength in various aspects, anti-chipping property and water resistance of a coating film are inferior. On the other hand, when the acid value of the mixture exceeds 60 mg KOH/g, polymerization stability of resin is deteriorated, and stability in the above-described aspects is inversely deteriorated, leading to weak water resistance of the resulting coating film. For this reason, the acid value of the mixture should be in a range of 2 to 60 mg KOH/g, preferably in a range of 5 to 50 mg KOH/g. As described above, it is important to use carboxyl group-containing monomers for the acid group-containing polymerizable unsaturated monomers (b2). In the monomers (b2), the carboxyl group-containing monomer makes up preferably 50% by weight or more, more preferably 80% by weight or more.

The mixture of the monomer components should have a hydroxyl group value in a range from 10 to 120 mg KOH/g. By causing the hydroxyl group value of the mixture to satisfy this range, resin obtaines suitable hydrophilicity, workability and stability against freezing when used as a coating composition containing a resin emulsion. In addition, curing reactivity with melamine resin and an isocyanate-based curing agent is sufficient. When the hydroxyl group value is less than 10 mg KOH/g, a curing reaction with a curing agent is insufficient, causing a coating film to show weak mechanical and anti-chipping properties as well as poor water resistance and solvent resistance. On the other hand, when the hydroxyl group value exceeds 120 mg KOH/g, water resistance of the resulting coating film is inversely reduced, compatibility with the curing agent is deteriorated, and strain occurs in a coating film that leads to non-uniform curing reaction. As a result, strength in various aspects of a coating film, particularly anti-chipping property, solvent resistance and water resistance become deteriorated. Accordingly, the hydroxyl group value is in a range of 10 to 120 mg KOH/g, preferably in a range of 20 to 100 mg KOH/g.

In addition, 0.5 to 10 weight parts, more preferably 1 to 8 weight parts of the crosslinkable monomers (b4) may be used for total amount of 100 weight parts of the monomers (b1), (b2) and (b3). Depending on the type of the monomer (b4), a crosslinked structure is provided for the water-dispersible acrylic resin (B) when the above range is satisfied, thus enhancing removability of an attached coating when cleaning, and mechanical strength of a coating film, particularly anti-chipping property, solvent resistance and water resistance. If the amount of the crosslinkable monomers (b4) is less than 0.5 weight parts, crosslinked structures are not sufficiently formed in a coating film, and effects of enhancing anti-chipping property, solvent resistance and water resistance of a coating film can not be easily obtained. On the other hand, when the amount of the crosslinkable monomers (b4) exceeds 10 weight parts, disadvantageous events such as gelation may occur during resin preparation process. Alternatively, although there is no problem in the resin preparation process, a non-uniform coating film may be formed.

Emulsion copolymerization can be performed by heating an aqueous solution containing the monomer components with constant mixing under the presence of a radical polymerization initiator and an emulsifier. When a reaction temperature is, for example, in a range substantially from 30° C. to 100° C., a reaction time is preferably around 1 to 10 hours. The reaction temperature may be regulated by adding at once or by adding dropwise the monomer mixture or a monomer pre-emulsified solution to a reaction vessel in which water and an emulsifier are placed.

As the radical polymerization initiator, publicly known initiators which are usually used in emulsion polymerization of acrylic resin can be used. Specifically, as a water-soluble free radical polymerization initiator, for example, persulfate such as potassium persulfate, sodium persulfate and ammonium persulfate is used in the form of an aqueous solution. In addition, a so-called redox system initiator in which an oxidizing agent such as potassium persulfate, sodium persulfate, ammonium persulfate, hydrogen peroxide, tert-butylhydroperoxide, tert-butylperoxi-sec-propylcarbonate and tert-butylperoximaleate, and a reducing agent such as sodium hydrogen sulfite, sodium thiosulfate, rongalite and ascorbic acid are combined, is used in the form of an aqueous solution.

As an emulsifier, an anionic or nonionic emulsifier selected from micelle compounds including a hydrocarbon group having 6 or more carbon atoms, and a hydrophilic part such as carboxylic acid salt, sulfonic acid salt or sulfuric acid salt hemiester in the same molecule is used. Among them, examples of the anionic emulsifier include an alkali metal salt or an ammonium salt of a sulfuric acid hemiester of alkylphenols or higher alcohols; an alkali metal salt or an ammonium salt of alkyl or allyl sulfonate; and an alkali metal salt or an ammonium salt of a sulfuric acid hemiester of polyoxyethylene alkyl phenyl ether, polyoxyethylene alkyl ether or polyoxyethylene allyl ether. Further, examples of the nonionic emulsifier include polyoxyethylene alkyl phenyl ether, polyoxyethylene alkyl ether or polyoxyethylene allyl ether. In addition to these general-use anionic and nonionic emulsifier, various anionic or nonionic reactive emulsifyiers having a radical-polymerizable unsaturated double bond in a molecule, that is, having a group such as acrylic-based, methacrylic-based, propenyl-based, allyl-based, allyl ether-based, and maleic acid-based, can be appropriately used alone or in combination of two or more.

The specific examples of the above-described emulsifiers include ADEKA REASOAP series, ADEKA PLURONIC series, ADEKA TOL series (manufactured by Asahi Denka Co., Ltd.), NOIGEN series, AQUALON series, HITENOL series (manufactured by Dai-ichi Kogyo Seiyaku Co., Ltd), ELMINOL series (manufactured by Sanyo Chemical Industries, Ltd), Neucol series, Antox series (manufactured by Nippon Nyukazai Co., Ltd), EMAL series, LATEMUL series and EMULGEN series (manufactured by Kao Corporation). Furthermore, from the viewpoint of being environmental-endocrine-disrupters-free, ADEKA REASOAP SR-10, ADEKA REASOAP SR-20 (manufactured by Asahi Denka Co., Ltd.), AQUALON KH-10 (manufactured by Dai-ichi Kogyo Seiyaku Co., Ltd), LATEMUL PD-104 (manufactured by Kao Corporation) and the like are preferable.

Upon emulsion polymerization, an additive for regulating a molecular weight (chain transfer agent), such as a mercaptan-based compound and a lower alcohol is used together in many cases as appropriate depending on the circumstances in view of accelerating emulsion polymerization, promoting smooth and uniform formation of a coating film, and improving adhesion ability to a substrate.

As emulsion polymerization, any polymerization method can be adopted, such as a one-stage method of continuously adding a monomer dropwise uniformly, a core/shell polymerization method which is a multi-stage monomer feeding method, and a power feed polymerization method of continuously changing a composition of a monomer to be fed during polymerization. Thus, copolymer resin to be used in the present invention is prepared. A weight average molecular weight of the resulting copolymer resin is not particularly limited but is generally around 50,000 to 1,000,000, and preferably around 100,000 to 800,000.

Furthermore, a basic compound is added to the resultant copolymer resin so that a part or whole of carboxylic acid is neutralized to maintain stability of the copolymer resin. Thus, the water-dispersible acrylic resin (B) is prepared. As the basic compounds, ammonia, various amines, alkali metals are generally used. They are also used in the present invention as appropriate.

In the present invention, the curing agent (C) is further added to the aforementioned water-dispersible polyurethane composition (A) and to the water-dispersible acrylic resin (B), thereby forming a water-based intermediate coating composition. The curing agent (C) is not particularly limited as long as it can initiate a curing reaction with any one of the water-dispersible polyurethane composition (A) and the water-dispersible acrylic resin (B) or both of them, and to be mixed in the water-based intermediate coating composition. Examples of the curing agents include melamine resin, isocyanate resin, an oxazoline-based compound and a carbodiimide-based compound. The compounds are used alone or in combination of two or more.

The melamine resin is not particularly limited, and melamine resin that is usually used as a curing agent can be used. For example, an alkyletherized melamine resin is preferable, and a melamine resin substituted with a methoxy group and/or a butoxy group is more preferable. Examples of such melamine resin include CYMEL 325, CYMEL 327, CYMEL 370, and MYCOAT 723, which have a methoxy group alone; CYMEL 202, CYMEL 204, CYMEL211, CYMEL232, CYMEL235, CYMEL236, CYMEL238, CYMEL 254, CYMEL 266 and CYMEL 267, which have both of a methoxy group and a butoxy group (all trade name, manufactured by Nihon Cytec Industries Inc.); and MYCOAT 506 (trade name, manufactured by Nihon Cytec Industries Inc.), U-VAN 20N60 and U-VAN 20SE (all trade name, manufactured by Mitsui Chemicals, Inc.) and Super Beckamine 13-548 (trade name, manufactured by Dainippon Ink and Chemicals), which have a butoxy group alone. These resins may be used alone or in combination of two or more.

The isocyanate resin is obtained by blocking a diisocyanate compound with a suitable blocking agent. The diisocyanate compound is not particularly limited as long as it has two or more isocyanate groups in one molecule. Examples thereof include: aliphatic diisocyanates such as hexamethylene diisocyanate (HMDI) and trimethylhexamethylene diisocyanate (TMDI); alicyclic diisocyanates such as isophorone diisocyanate (IPDI); aromatic-aliphatic diisocyanates such as xylylene diisocyanate (XDI); aromatic diisocyanates such as tolylene diisocyanate (TDI) and 4,4-diphenylmethane diisocyanate (MDI); hydrogenated diisocyanates such as dimeryl diisocyanate (DDI), hydrogenated TDI (HTDI), hydrogenated XDI (H6XDI) and hydrogenated MDI (H12MDI), and adducts and nurates of the above-mentioned diisocyanates. Further, these compounds are appropriately used alone or in combination of two or more.

The blocking agent for blocking the diisocyanate compound is not particularly limited, and examples thereof include oximes such as methylethylketoxime, acetoxime and cyclohexanoneoxime; phenols such as m-cresol and xylenol; alcohols such as butanol, 2-ethylhexanol, cyclohexanol, and ethylene glycol monoethyl ether; lactams such as ε-caprolactam; diketones such as diethyl malonate and acetoaceate; mercaptans such as thiophenol; ureas such as thiouric acid; imidazoles; and carbamic acids. Among them, oximes, phenols, alcohols, lactams and diketones are preferable.

The oxazoline-based compound is preferably a compound having two or more 2-oxazoline groups, and examples thereof include the below-mentioned oxazolines and oxazoline group-containing polymers. These compounds can be used alone or in combination of two or more. The oxazoline-based compound is obtained by using any of the following methods: a method of dehydrating and cyclizing amido alcohol by heating it in the presence of a catalyst; a method of synthesizing the oxazoline-based compound from alkanolamine and nitrile; a method of synthesizing the oxazoline-based compound from alkanolamine and carboxylic acid, and the like.

Examples of the oxazolines include 2,2′-bis-(2-oxazoline), 2,2′-methylene-bis-(2-oxazoline), 2,2′-ethylene-bis-(2-oxazoline), 2,2′-trimethylene-bis-(2-oxazoline), 2,2′-tetramethylene-bis-(2-oxazoline-), 2,2′-hexamethylene-bis-(2-oxazoline), 2,2′-octamethylene-bis-(2-oxazoline), 2,2′-ethylene-bis-(4,4′-dimethyl-2-oxazoline), 2,2′-p-phenylene-bis-(2-oxazoline), 2,2′-m-phenylene-bis-(2-oxazoline), 2,2′-m-phenylene-bis-(4,4′-dimethyl-2-oxazoline), bis-(2-oxazolinylcyclohexane) sulfide, and bis-(2-oxazolinylnorbornane) sulfide. The compounds can be appropriately used alone or in combination of two or more.

The oxazoline group-containing polymer is one where addition-polymerizable oxazoline and, when needed, at least one type of another polymerizable monomer are polymerized. Examples of the addition-polymerizable oxazolines include 2-vinyl-2-oxazoline, 2-vinyl-4-methyl-2-oxazoline, 2-vinyl-5-methyl-2-oxazoline, 2-isopropenyl-2-oxazoline, 2-isopropenyl-4-methyl-2-oxazoline, and 2-isopropenyl-5-ethyl-2-oxazoline. These can be appropriately used alone or in combination of two or more. Among them, 2-isopropenyl-2-oxazoline is preferable because of its industrial availability.

An amount of addition-polymerizable oxazoline to be used is not particularly limited. However, it is preferably 1% by weight or more in oxazoline group-containing polymer. When the amount is less than 1% by weight, curing is insufficient, and durability and water resistance may be deteriorated.

The above-described another polymerizable monomer is not particularly limited as far as it is a monomer which is copolymerizable with addition-polymerizable oxazoline and does not react with an oxazoline group. Examples thereof include (meth)acrylates such as methyl (meth)acrylate, butyl (meth)acrylate and 2-ethylhexyl (meth)acrylate; unsaturated nitrites such as (meth)acrylonitrile; unsaturated amides such as (meth)acrylamide and N-methylol (meth)acrylamide; vinyl esters such as vinyl acetate and vinyl propionate; vinyl ethers such as methyl vinyl ether and ethyl vinyl ether; α-olefins such as ethylene and propylene; halogenated α, β-unsaturated monomers such as vinyl chloride, vinylidene chloride and vinyl fluoride; and α,β-unsaturated aromatic monomers such as styrene and α-methylstyrene. The monomers can be appropriately used alone or in combination of two or more.

The oxazolizine group-containing polymer can be prepared by subjecting addition-polymerizable oxazoline and, if needed, at least one type of another polymerizable monomer to a publicly known polymerization, such as suspension polymerization, solution polymerization or emulsion polymerization. The form in which oxazolizine group-containing compound is provided is any of, but not limited to, an organic solvent solution, an aqueous solution, a non-aqueous dispersion, an emulsion and the like.

For the carbodiimide compounds, those prepared by various methods can be used, and a basic example thereof is a carbodiimide compound obtained by preparing an isocyanate-terminated polycarbodiimide by a condensation reaction of organic diisocyanate, which is accompanied by removal of carbon dioxide. More specifically, a preferable example includes a hydrophilization-modified carbodiimide compound obtained by using the method including the steps of: upon preparation of a polycarbodiimide compound, causing a polycarbodiimide compound containing at least two isocyanate groups in one molecule to react with polyol having a hydroxy group at molecular terminals thereof at such a ratio that a mol amount of an isocyanate group of the polycarbodiimide compound is larger than that of a hydroxy group of the polyol; and causing a hydrophilizing agent having active hydrogen and a hydrophilic part to react with the thus obtained reaction product.

The carbodiimide compound containing at least two isocyanate groups in one molecule is not particularly limited. However, a carbodiimide compound having an isocyanate group at both terminals is preferable from a viewpoint of reactivity. A process for preparing a carbodiimide compound having an isocyanate group at both terminals is well-known to those skilled in the art. For example, a condensation reaction of organic diisocyanate, which is accompanied by removal of carbon dioxide, can be used.

The water-dispersible polyurethane composition (A) is preferably contained in the water-based intermediate coating composition in such an amount that the ratio of the solid content of the water-dispersible polyurethane composition (A) relative to the total solid contents of the water-dispersible polyurethane composition (A), the water-dispersible acrylic resin (B) and the curing agent (C) is within a range of 5 to 35% by weight, more preferably in a range of 5 to 30% by weight. When the content of the water-dispersible polyurethane composition (A) is less than the above range, the effect of increasing anti-chipping property is reduced. Meanwhile, when the content thereof exceeds the above range, paint-removability becomes weaker. In any of the above cases, effects of the present invention may not be achieved. In addition, the ratio of the solid content of the water-dispersible acrylic resin (B) relative to the total solid contents of the water-dispersible polyurethane composition (A), the water-dispersible acrylic resin (B) and the curing agent (C) is preferably within a range of 15 to 90% by weight, more preferably in a range of 20 to 80% by weight. When the content of the water-dispersible acrylic resin (B) is less than the above range, anti-chipping property tends to be reduced. Meanwhile, when the content of the water-dispersible acrylic resin (B) exceeds the above range, water resistance tends to be reduced. In any of the above cases, effects of the present invention may not be achieved.

Furthermore, the curing agent (C) is preferably contained in the water-based intermediate coating composition in such an amount that the ratio of the solid content of the curing agent (C) relative to the total solid contents of the water-dispersible polyurethane composition (A), the water-dispersible acrylic resin (B) and the curing agent (C) is within a range of 5 to 50% by weight but preferably in a range of 5 to 30% by weight. When the solid content of the curing agent (C) is less than 5% by weight, water resistance of the resultant coating film tends to be reduced. Meanwhile, when the solid content of the curing agent (C) exceeds 50% by weight, anti-chipping property of the resultant coating film tends to be reduced.

An emulsion, in which a curing agent and polymer are combined, can be added to the water-based coating composition of the present invention, that is, to a mixture of the water-dispersible polyurethane composition (A), the water-dispersible acrylic resin (B) and the curing agent (C). For such a composite emulsion, an curing agent-contained emulsion (D) can be cited. The curing agent-contained emulsion (D) can be prepared as follows: polymerizable unsaturated monomers (d1), acid group-containing polymerizable unsaturated monomers (d2) and hydroxyl group-containing polymerizable unsaturated monomers (d3) are mixed; the resultant monomer mixture, which has a glass transition temperature of −30° C. to 30° C. but preferably −25° C. to 25° C., an acid value ranging from 5 to 15 mg KOH/g and a hydroxyl group value ranging from 30 to 100 mg KOH/g but preferably 35 to 90 mg KOH/g, is subjected to emulsion polymerization under the presence of a curing agent (C′).

For the curing agent (C′), melamine resin, isocyanate resin, an oxazoline-based compound or a carbodiimide-based compound can be adopted as in the case of the aforementioned curing agent (C). Two or more of these compounds can be used together. Among them, preferably, melamine has a methoxy group and butoxy group and where the (methoxy/butoxy) ratio is in a range of 70/30 to 0/100. Use of melamine resin where the (methoxy/butoxy) ratio is within the above range improves recoat adhesion property.

Moreover, compatibility of the melamine resin with water is preferably 10 ml/g or less. Water-compatibility can be determined by the following method. Specifically, 5 g of a sample (here, melamine resin) is placed into 200 ml beaker by using a direct-reading balance and 5 g of isopropylalcohol is added thereto, followed by mixing. Thus, the sample is dissolved into isopropylalcohol. Subsequently, titration is performed with ion-exchanged water while constantly mixing the resultant solution at 20° C. Here, titration is terminated at a point where No. 5 type characters (11-point characters) on a printed matter, which is placed under the 200 ml beaker, are made illegible when viewed from above the beaker.

In addition, compatibility of the melamine resin with xylene is preferably 100 ml/g or more. Xylene-compatibility can be determined by the following method. Specifically, 10 g of a sample (here, melamine resin) is placed into 200 ml beaker by using a direct-reading balance. Subsequently, titration is performed with xylene while mixing the resultant solution at 25° C. Here, titration is terminated at a point where No. 5 type characters (11-point characters) on a printed matter, which is placed under the 200 ml beaker, are made illegible when viewed from above the beaker.

It is preferable that the curing agent (C′) be added in such an amount that the ratio of the curing agent (C′) relative to total solid contents of a curing agent-contained emulsion to be prepared is in a range of 10 to 30% by weight, more preferably in a range of 20 to 25% by weight.

In addition, the polymerizable unsaturated monomers (d1) can be appropriately selected from monomers that are used in the aforementioned monomers (b1) of the water-dispersible acrylic resin (B), that is, monomers that include at least one monomer selected from (meth)acrylic acid alkyl esters and, if needed, at least one monomer selected from the group consisting of styrene-based monomers, (meth)acrylonitrile and (meth)acrylamide. Similarly, the acid group-containing polymerizable unsaturated monomer (d2) and the hydroxyl group-containing polymerizable unsaturated monomer (d3) can be appropriately selected from the aforementioned acid group-containing polymerizable unsaturated monomers (b2) and the hydroxyl group-containing polymerizabile unsaturated monomers (b3), respectively.

The type and mixing ratio of the monomer components (d1), (d2) and (d3) are selected so that the mixture thereof shows a glass transition temperature of −30° C. to 30° C., an acid value of 5 to 15 mg KOH/g, and a hydroxyl group value of 30 to 100 mg KOH/g. Subsequently, the selected monomers are subjected to aforementioned emulsion polymerization. Thus, the curing agent-contained emulsion (D) is produced.

Furthermore it is also preferable that polymerizable monomers (d4) having at least two radical polymerizable unsaturated groups in a molecule be mixed in such an amount that it constitutes 1 to 15% by weight, preferably 5 to 10% by weight of total weight of the monomers (d1) to (d4), followed by emulsion polymerization. Examples of compounds that can be used as the monomers (d4) are exemplified as the polyfunctional vinyl-based monomers used for the monomers (b4).

Furthermore, the following operations are preferably performed: that an anionic reactive emulsifier, having radical polymerizable unsaturated groups in molecules, be mixed in such an amount that it constitutes 1 to 10% by weight, preferably 3 to 7% by weight of the total weight the monomer components and the curing agent (C′); and that after emulsion polymerization, neutralization is performed with a tertiary amine, which is 15 to 100% equivalent amount, preferably 30 to 100% equivalent amount relative to the contained acid groups.

Upon emulsion polymerization of the curing agent-contained emulsion (D), it is preferable that the curing agent (C′), the monomers (d1) to (d3), the monomers (d4) when needed, the anionic reactive emulsifier and other components be emulsified by use of a high-speed shearing machine to produce a pre-emulsion having particle size of 200 nm or less, followed by emulsion polymerization of this pre-emulsion. In addition, it is particularly preferable to performing redox emulsion polymerization by using a redox initiator and by setting polymerization temperature to 35° C. to 50° C.

In a case where the curing agent-contained emulsion (D) is contained in the water-based intermediate coating film of the present invention, the amount thereof preferably constitutes 5 to 70% by weight, more preferably 10 to 60% by weight of the total amount of the solid contents of resin in the water-based intermediate coating composition (i.e., the solid contents of water-dispersible polyurethane composition (A), water-dispersible acrylic resin (B), curing agent (C) and curing agent-contained emulsion (D)). If the content of the curing agent-contained emulsion (D) is within the above range, excellent water resistance, recoat adhesion property and anti-chipping property can be provided.

Generally, water-based detergents are used to clean spray guns and the like which are used for applying water-based coatings. Accordingly, a conventional thought on a curing agent has been that the higher the water-compatibility of the curing agent is as is with, the more excellent the paint-removability which the curing agent can provide, and water-soluble melamine or the like has been considered as appropriate. Moreover, it has been difficult to cause a hydrophobic curing agent to uniformly disperse in water-based coatings, or granted that the dispersion was possible, sufficient storage stability of coatings has not been obtained. However, use of the curing agent-contained emulsion (D) according to the present invention makes it possible to achieve uniform and stable dispersion of the curing agent (C′) in polymer, enabling to provide water-based coatings which include hydrophobic curing agents and which are excellent in storage stability. In addition, although a hydrophobic curing agent is contained, excellent paint-removability is provided even when water-based detergents are used. This is an amazing fact.

The water-based intermediate coating composition of the present invention can further contain the following components when needed. For example, hindered amine light stabilizers, antioxidants, ultraviolet absorbers, resin components other than the above-described water-dispersible polyurethane composition (A) and water-dispersible acrylic resin (B), dispersant-pigment dispersion pastes and thickeners. Particularly, hindered amine light stabilizers, antioxidants and ultraviolet absorbers are preferably used because the water-based intermediate coating composition of the present invention is mainly intended for automobile exterior application.

Examples of the hindered amine light stabilizer include 2,2,6,6-tetramethyl-4-piperidyl stearate, 1,2,2,6,6-pentamethyl-4-piperidyl stearate, 2,2,6,6-tetramethyl-4-piperidyl benzoate, bis(2,2,6,6-tetramethyl-4-piperidyl) sebacate, bis(1,2,2,6,6-pentamethyl-4-piperidyl) sebacate, bis(1-octoxy-2,2,6,6-tetramethyl-4-piperidyl) sebacate, 1,2,2,6,6,-pentamethyl-4-piperidylmethyl methacrylate, 2,2,6,6-tetramethyl-4-piperydylmethyl methacrylate, tetrakis(2,2,6,6-tetramethyl-4-piperidyl)-1,2,3,4-butanetetracarboxylate, tetrakis(1,2,2,6,6-pentamethyl-4-piperidyl)-1,2,3,4-butanetetracarboxylate, bis(2,2,6,6-tetramethyl-4-piperidyl)bis(tridecyl)-1,2,3,4-butanetetracarboxylate, bis(1,2,2,6,6-pentamethyl-4-piperidyl)bis(tridecyl)-1,2,3,4-butanetetracarboxylate, bis(1,2,2,6,6-pentamethyl-4-piperidyl)-2-butyl-2-(3,5-di-tert-butyl-4-hydroxybenzyl) malonate, 1-(2-hydroxyethyl)-2,2,6,6-tetramethyl-4-piperidinol/diethyl succinate polycondensate, 1,6-bis(2,2,6,6-tetramethyl-4-piperidylamino)hexane/dibromo ethane polycondensate, 1,6-bis(2,2,6,6-tetramethyl-4-piperidylamino)hexane/2,4-dichloro-6-morpholino-s-triazin polycondensate, 1,6-bis(2,2,6,6-tetramethyl-4-piperidylamino)hexane/2,4-dichloro-6-tert-octylamino-s-triazin polycondensate, 1,5,8,12-tetrakis[2,4-bis(N-butyl-N-(2,2,6,6-tetramethyl-4-piperidyl)amino)-s-triazin-6-yl]-1,5,8,12-tetraazadodecane, 1,5,8,12-tetrakis[2,4-bis(N-butyl-N-(1,2,2,6,6-pentamethyl-4-piperidyl)amino)-s-triazin-6-yl]-1,5,8,12-tetraazadodecane, 1,6,11-tris[2,4-bis(N-butyl-N-(2,2,6,6,-tetramethyl-4-piperidyl)amino)-s-triazin-6-ylamino]undecane, 1,6,11-tris[2,4-bis(N-butyl-N-(1,2,2,6,6,-pentamethyl-4-piperidyl)amino)-s-triazin-6-ylamino]undecane, 3,9-bis[1,1-dimethyl-2-[tris(2,2,6,6-tetramethyl-4-piperidyloxycarbonyloxy)butylcarbonyloxy]ethyl]-2,4,8,10-tetraoxaspiro[5.5]undecane and 3,9-bis[1,1-dimethyl-2-[tris(1,2,2,6,6-pentamethyl-4-piperidyloxycarbonyloxy)butylcarbonyloxy]ethyl]-2,4,8,10-tetraoxaspiro[5.5]undecane.

Examples of the ultraviolet absorber include 2-hydroxybenzophenones such as 2,4-dihydroxybenzophenone, 2-hydroxy-4-methoxybenzophenone, 2-hydroxy-4-octoxybenzophenone, and 5,5′-methylenebis(2-hydroxy-4-methoxybenzophenone); 2-(2-hydroxyphenyl)benzotriazoles such as 2-(2-hydroxy-5-methylphenyl)benzotriazole, 2-(2-hydroxy-5-tert-octylphenyl)benzotriazole, 2-(2-hydroxy-3,5-di-tert-butylphenyl)-5-chlorobenzotriazole, 2-(2-hydroxy-3-tert-butyl-5-methylphenyl)-5-chlorobenzotriazole, 2-(2-hydroxy-3,5-dicumylphenyl)benzotriazole, 2,2′-methylenebis(4-tert-octyl-6-benzotriazolylphenol), polyethyleneglycol ester of 2-(2-hydroxy-3-tert-butyl-5-carboxyphenyl)benzotriazole, 2-[2-hydroxy-3-(2-acryloyloxyethyl)-5-methylphenyl]benzotriazole, 2-[2-hydroxy-3-(2-methacryloyloxyethyl)-5-tert-butylphenyl]benzotriazole 2-[2-hydroxy-3-(2-methacryloyloxyethyl)-5-tert-octylphenyl]benzotriazole, 2-[2-hydroxy-3-(2-methacryloyloxyethyl)-5-tert-butylphenyl]-5-chlorobenzotriazole, 2-[2-hydroxy-5-(2-methacryloyloxyethyl)phenyl]benzotriazole, 2-[2-hydroxy-3-tert-butyl-5-(2-methacryloyloxyethyl)phenyl]benzotriazole, 2-[2-hydroxy-3-tert-amyl-5-(2-methacryloyloxyethyl)phenyl]benzotriazole, 2-[2-hydroxy-3-tert-butyl-5-(3-methacryloyloxypropyl)phenyl]-5-chlorobenzotriazole, 2-[2-hydroxy-4-(2-methacryloyloxymethyl)phenyl]benzotriazole, 2-[2-hydroxy-4-(3-methacryloyloxy-2-hydroxypropyl)phenyl]benzotriazole and 2-[2-hydroxy-4-(3-methacryloyloxypropyl)phenyl]benzotriazol e; 2-(2-hydroxyphenyl)-4,6-diaryl-1,3,5-triazins such as 2-(2-hydroxy-4-methoxyphenyl)-4,6-diphenyl-1,3,5-triazin, 2-(2-hydroxy-4-hexyloxyphenyl)-4,6-diphenyl-1,3,5-triazin, 2-(2-hydroxy-4-octoxyphenyl)-4,6-bis(2,4-dimethylphenyl)-1, 3,5-triazin, 2-[2-hydroxy-4-(3-C_{12 to 13} mixed alkoxy-2-hydroxypropoxy)phenyl]-4,6-bis(2,4-dimethylphenyl)-1,3,5-triazin, 2-[2-hydroxy-4-(2-acryloyloxyethoxy)phenyl]-4,6-bis(4-methylphenyl)-1,3,5-triazin, 2-(2,4-dihydroxy-3-allylphenyl)-4,6-bis(2,4-dimethylphenyl)-1,3,5-triazin and 2,4,6-tris(2-hydroxy-3-methyl-4-hexyloxyphenyl)-1,3,5-triazin; benzoates such as phenyl salicylate, resorcinol monobenzoate, 2,4-di-tert-butylphenyl-3,5-di-tert-butyl-4-hydroxybenzoate, octyl(3,5-di-tert-butyl-4-hydroxy) benzoate, dodecyl(3,5-di-tert-butyl-4-hydroxy) benzoate, tetradecyl(3,5-di-tert-butyl-4-hydroxy) benzoate, hexadecyl(3,5-di-tert-butyl-4-hydroxy) benzoate, octadecyl(3,5-di-tert-butyl-4-hydroxy) benzoate and behenyl(3,5-di-tert-butyl-4-hydroxy) benzoate; substituted oxanilides such as 2-ethyl-2′-ethoxyoxanilide and 2-ethoxy-4′-dodecyloxanilide; cyanoacrylates such as ethyl-α-cyano-β,β-diphenylacrylate and methyl-2-cyano-3-methyl-3-(p-methoxyphenyl)acrylate; and various metal salts and metal chelates, particularly salts or chelates of nickel or chrome.

Examples of the phosphorus-based anti-oxidant include triphenyl phosphite, tris (2,4-di-tert-butylphenyl) phosphite, tris(2,5-di-tert-butylphenyl) phophite, tris(nonylphenyl) phosphite, tris(dinonylphenyl) phosphite, tris(mono, di and mixed-nonylphenyl) phosphite, diphenyl acid phosphite, 2,2′-methylenebis(4,6-di-tert-butylphenyl)octyl phosphite, diphenyldecyl phosphite, diphenyloctyl phosphite, di (nonylphenyl) pentaerythritol diphosphite, phenyl diisodecyl phosphite, tributyl phosphite, tris(2-ethylhexyl) phosphite, tridecyl phosphite, trilauryl phosphite, dibutyl acid phosphite, dilauryl acid phosphite, trilauryl trithiophosphite, bis(neopentyl glycol)1,4-cyclohexanedimethyl diphosphite, bis(2,4-di-tert-butylphenyl)pentaerythritol diphosphite, bis(2,5-di-tert-butylphenyl)pentaerythritol diphosphite, bis(2,6-di-tert-4-methylphenyl)pentaerythritol diphosphite, bis(2,4-dicumylphenyl)pentaerythritol diphosphite, distearylpentaerythritol diphosphite, tetra (C_{12 to 15} mixed alkyl)-4,4′-isopropylidene diphenyl phosphite, bis[2,2′-methylenebis(4,6-diamylphenyl)]isopropylidene diphenyl phosphite, tetratridecyl 4,4′-butylidene-bis(2-tert-butyl-5-methylphenol) diphosphite, hexa(tridecyl) 1,1,3-tris(2-methyl-5-tert-butyl-4-hydroxyphenyl)butane triphosphite, tetrakis(2,4-di-tert-butylphenyl)biphenylene diphosphonite, tris(2-[(2,4,7,9-tetrakis-tert-butyl-dibenzo[d,f][1,3,2]-di oxaphosphepin-6-yl)oxy] ethyl) amine, 9,10-dihydro-9-oxa-10-phosphaphenanthrene-10-oxide, and 2-butyl-2-ethylpropanediol 2,4,6-tri-tert-butylphenol monophosphite.

Examples of the phenolic anti-oxidant include 2,6-di-tert-butyl-p-cresol, 2,6-diphenyl-4-octadecyloxyphenol, stearyl(3,5-di-tert-butyl-4-hydroxyphenyl) propionate, distearyl(3,5-di-tert-butyl-4-hydroxybenzyl) phosphonate, tridecyl 3,5-di-tert-butyl-4-hydroxybenzyl thioacetate, thiodiethylenebis[(3,5-di-tert-butyl-4-hydroxyphenyl)propionate], 4,4′-thiobis(6-tert-butyl-m-cresol), 2-octylthio-4,6-di(3,5-di-tert-butyl-4-hydroxyphenoxy)-s-triazin, 2,2′-methylenebis(4-methyl-6-tert-butylphenol), bis[3,3-bis(4-hydroxy-3-tert-butylphenyl)butylic acid]glycol ester, 4,4′-butylidenebis(2,6-di-tert-butylphenol), 4,4′-butylidenebis(6-tert-butyl-3-methylphenol), 2,2′-ethylidenbis(4,6-di-tert-butylphenol), 1,1,3-tris(2-methyl-4-hydroxy-5-tert-butylphenyl)butane, bis[2-tert-butyl-4-methyl-6-(2-hydroxy-3-tert-butyl-5-methylbenzyl)phenyl]terephthalate, 1,3,5-tris(2,6-dimethyl-3-hydroxy-4-tert-butylbenzyl) isocyanurate, 1,3,5-tris(3,5-di-tert-butyl-4-hydroxybenzyl) isocyanurate, 1,3,5-tris(3,5-di-tert-butyl-4-hydroxybenzyl)-2,4,6-trimethylbenzene, 1,3,5-tris[(3,5-di-tert-butyl-4-hydroxyphenyl)propionyloxyethyl]isocyanurate, tetrakis[methylene-3-(3′,5′-di-tert-butyl-4′-hydroxyphenyl) propionate]methane, 2-tert-butyl-4-methyl-6-(2-acryloyloxy-3-tert-butyl-5-methylbenzyl)phenol, 3,9-bis[2-(3-tert-butyl-4-hydroxy-5-mehtylhydrocinnamoyloxy)-1,1-dimethylethyl]-2,4,8,10-tetraoxaspiro[5.5]undecane and triethylene glycol bis[β-(3-tert-butyl-4-hydroxy-5-methylphenyl)propionate].

Examples of the thioether-antioxidant include dialkyl thiodipropionates such as dilauryl, dimyristyl, myristylstearyl, and distearyl ester of thiodipropionic acid, and β-alkylmercaptopropionic acid ester of polyol, such as pentaerythritol tetra(β-docecylmercaptopropionate).

When each of the hindered amine light stabilizer, antioxidant and ultraviolet absorber is compounded in an amount of 0.001 part by weight or less per 100 parts by weight of the solid contents of resin in a water-based intermediate coating composition, sufficient effects cannot be provided in some cases. Meanwhile, when each of these agents is compounded in an amount of 10 parts by weight or more, dispersion property and physical properties of a coating may be influenced. For this reason, each of the agents is preferably compounded in an amount of 0.001 to 10 parts by weight, more preferably 0.01 to 5 parts by weight. Here, the following methods are preferably adopted as the method of adding the hindered amine light stabilizer, antioxidant and ultraviolet absorber: a method of adding these agents either to the polyol component (a2) of the water-dispersible polyurethane composition (A) or to the hydroxyl group-containing polymerizable unsaturated monomers (b3) of the water-dispersible acrylic resin (B); a method of adding these agents to pre-polymer of the water-dispersible polyurethane composition (A); a method of adding these agents to an aqueous phase which is formed when either the water-dispersible polyurethane composition (A) or the water-dispersible acrylic resin (B) is dispersed in water; and a method of adding these agents after water dispersion is performed. In light of simplicity of operation, the method of adding the agents to the polyol component (a2) or hydroxyl group-containing polymerizable unsaturated monomers (b3), and the method of adding the agents to the pre-polymer of the water-dispersible polyurethane composition (A) are preferable.

Examples of the other resin components include, but are not limited to, acrylic resin and urethane resin other than ones described above, polyester resin, carbonate resin and epoxy resin. These resin components are preferably mixed in an amount of 50% by weight or less relative to total solid contents of resin included in a water-based intermediate coating composition.

The dispersant-pigment dispersion paste can be obtained by previously dispersing a pigment and a pigment dispersant in an aqueous medium. The solid content of the pigment dispersant does not contain volatile basic substances at all, or contains volatile basic substances in an amount of 3% by weight or less. With respect to the water-based intermediate coating composition of the present invention, use of the pigment dispersant reduces an amount of volatile basic substances in a coating film formed from the water-based intermediate coating, suppressing yellowing of the resulting multilayer coating film. Accordingly, it is not preferable that volatile basic substances are contained in an amount of more than 3% by weight in the solid content of a pigment dispersant, because the resulting multilayer coating film shows yellowing and a finished appearance is deteriorated.

The term “volatile basic substances” means basic substances having a boiling point of 300° C. or lower, and the examples thereof include inorganic and organic nitrogen-containing basic substances. Examples of inorganic basic substances include ammonia. Examples of organic basic substances include primary to tertiary amines including a straight or branched alkyl group having 1 to 20 carbon atoms, such as methylamine, dimethylamine, trimethylamine, ethylamine, diethylamine, triethylamine, isopropylamine, diisopropylamine and dimethyldodecylamine; primary to tertiary amines including a straight or branched hydroxyalkyl group having 1 to 20 carbon atoms, such as monoethanolamine, diethanolamine and 2-amino-2-methylpropanol; primary to tertiary amines including a straight or branched alkyl group having 1 to 20 carbon atoms and a straight or branched hydroxyalkyl group having 1 to 20 carbon atoms, such as dimethylethanolamine and diethylethanolamine; substituted or unsubstituted chain polyamines having 1 to 20 carbon atoms, such as diethylenetriamine and triethylenetetramine; substituted or unsubstituted cyclic monoamines having 1 to 20 carbon atoms, such as morpholine, N-methylmorpholine and N-ethylmorpholine; and substituted or unsubstituted cyclic polyamines having 1 to 20 carbon atoms, such as piperazine, N-methylpiperazine, N-ethylpiperazine and N,N-dimethylpiperazine.

The water-based intermediate coating composition of the present invention may contain volatile basic substances in as a component which is not for the pigment dispersant. Accordingly, the less the amount of the volatile basic substances contained in the pigment dispersant, the more preferable. That is, it is preferable that dispersing be performed by use of a pigment dispersant which contains substantially no volatile basic substances. In addition, it is further preferable not to use an amine neutralization-type pigment-dispersing resin which has been generally used. Further, it is preferable to use a pigment dispersant so that an amount of volatile basic substances per unit area 1 mm² is 7×10⁻⁶ mmol or less at a time of forming a multilayer coating film.

The pigment dispersant is resin having a structure containing both a pigment affinity moiety and a hydrophilic moiety. Examples of the pigment affinity moiety and the hydrophilic moiety include nonionic, cationic and anionic functional groups. The pigment dispersant may have two or more types of the functional groups in one molecule.

Examples of the nonionic functional groups include a hydroxyl group, an amide group and a polyoxyalkylene group. Examples of the cationic functional groups include an amino group, an imino group and a hydrazino group. In addition, examples of the anionic functional groups include a carboxyl group, a sulfonic acid group and a phosphoric acid group. The pigment dispersants can be prepared by using methods which are well known to those skilled in the art.

The pigment dispersant is not particularly limited as long as the solid content thereof does not contain volatile basic substances, or contains the volatile basic substances in an amount of 3% by weight or less. However, it is preferable that a pigment can be effectively dispersed by using a small amount of a pigment dispersant. For example, commercially available dispersants (hereinafter, all trade name) can be used. Specific examples thereof include: Disperbyk 190, Disperbyk 181, Disperbyk 182 (high-molecular copolymer) and Disperbyk 184 (high-molecular copolymer) which are anionic/nonionic dispersants, manufactured by Byk-Chemie; EFKAPOLYMER4550 which is an anionic/nonionic dispersant, manufactured by EFKA; and Solsperse27000 which is a nonionic dispersant, Solsperse41000 and Solsperse53095 which are an anionic dispersants, manufactured by Avecia.

The pigment dispersant preferably has a number average molecular weight of 1,000 to 100,000. When the molecular weight is less than 1,000, dispersion stability may not be sufficient. When the molecular weight exceeds 100,000, viscosity may become too high to handle. More preferably, the lower limit is 2,000 and the upper limit is 50,000. Further preferably, the lower limit is 4,000 and the upper limit is 50,000.

The dispersant-pigment dispersion paste can be obtained by mixing a pigment dispersant with a pigment in accordance with a known method. Upon preparation of a dispersant-pigment dispersion paste, it is preferable that the pigment dispersant be contained in such an amount that it constitutes 1 to 20% by weight of the solid content of the dispersant-pigment dispersion paste. If the amount of the pigment dispersant is less than 1% by weight, it is difficult to achieve stable pigment dispersion. Meanwhile, if the amount of the pigment dispersant exceeds 20% by weight, physical properties of a coating film may become inferior. Preferably, the lower limit is 5% by weight and the upper limit is 15% by weight.

The pigment is not particularly limited as long as it is one of the pigments which have been used in a conventional water-based coating. However, in order to improve weather resistance and ensure opacity, the pigment is preferably a coloring pigment. In particular, titanium dioxide is more preferable because of its excellency in both coloring and opacity and because of its inexpensiveness.

Examples of the pigments other than titanium dioxide include organic coloring pigments such as an azo chelate-based pigment, an insoluble azo-based pigment, a fused azo-based pigment, a phthalocyanine-based pigment, an indigo pigment, a perinone-based pigment, a perylene-based pigment, a dioxane-based pigment, a quinacridone-based pigment, an isoindolinone-based pigment, a diketopyrrolopyrrole-based pigment, a benzimidazolone-based pigment and a metal complex pigment; inorganic coloring pigments such as chrome yellow, yellow iron oxide, red iron oxide and carbon black. Extenders such as calcium carbonate, barium sulfate, clay and talc may be combined with the pigments.

Furthermore, for the pigment, a standard gray coating containing carbon black and titanium dioxide as main pigment ingredients may be used. Additionally, coatings having brightness and a hue which are compatible with a top coating, and coating having various coloring pigments can also be used.

The pigment is preferably contained in a water-based intermediate coating composition by such an amount that the ratio of pigment weight relative to a total weight of all resin solid contents and pigments contained in the water-based intermediate coating composition (PWC; pigment weight content) is in a range of 10 to 60% by weight. When the content is less than 10% by weight, hindering may be reduced. When the content exceeds 60% by weight, viscosity may increase at a curing process and flowability may reduce, leading to deterioration in appearance of the coating film in some cases.

It is preferable that the content of the pigment dispersant be in a range of 0.5% by weight to 10% by weight relative to the weight of a pigment. If the content is less than 0.5% by weight, reduced amount of the mixed pigment dispersant may cause reduction in dispersion stability of a pigment in some cases. If the content exceeds 10% by weight, physical properties of a coating film may become inferior. Preferably, the lower limit is 1% by weight, and the upper limit is 5% by weight.

The thickener is not particularly limited, and examples thereof include: cellulose series such as viscose, methylcellulose, ethylcellulose, hydroxyethylcellulose and, as commercially available products, Tylose MH and Tylose H (all trade name, manufactured by Hoechst); alkali-type thickeners such as sodium polyacrylate, polyvinyl alcohol, carboxymethylcellulose and, as commercially available products (hereinafter, all trade name), Primal ASE-60, Primal TT-615 and Primal RM-5 (all manufactured by Rohm & Haas, Inc.), and Ukarpolyfove (manufactured by Union Carbide); and association thickeners such as polyvinyl alcohol, polyethylene oxide and, as commercially available products (hereinafter, all trade name), Adecanol UH-420, Adecanol UH-462, Adecanol UH-472, UH-540 and Adecanol UH-814N (manufactured by Asahi Denka Co., Ltd.), Primal RH-1020 (manufactured by Rohm & Haas, Inc.), and Kuraray poval (manufactured by Kuraray Co., Ltd.). These may be used alone or in combination of two or more.

The inclusion of the thickener can increase a viscosity of a water-based intermediate coating composition. Thus, occurrence of sagging can be suppressed upon application of the water-based intermediate coating composition. In addition, occurrence of layer mixing between an intermediate coating film and a base coating film can be suppressed. As a result, in comparison with a coating composition which includes no thickeners, coating workability is improved and the resulting coating film can offer excellent finished appearance.

It is preferable that a thickener be used in an amount of 0.01 to 20 parts by weight per 100 parts by weight of the resin solid content of the water-based intermediate coating composition (i.e., solid content of all resin contained in a water-based intermediate coating). It is more preferable that a thickener be used in an amount of 0.1 to 10 parts by weight. If the amount is less than 0.01 part by weight, viscosity increasing effect is not obtained and sagging may occur at a time of coating. Meanwhile, if the amount exceeds 20 parts by weight, the resulting coating film may be deteriorated in appearance and in performance in various aspects.

Examples of other additives, which are usually added in addition to the aforementioned agents, include such as surface adjusting agents, pinhole inhibitors, dyes, film-forming aids, silane coupling agents, blocking inhibitors, viscosity adjusting agents, leveling agents, anti-foaming agents, gelation inhibitors, dispersion stabilizers, radical scavengers, heat resistance-providing agents, inorganic or organic fillers, plasticizers, lubricants, antistatic agents, reinforcing agents, catalysts, thixotropic agents, antibacterial agents, antimicrobial agents, antiseptic agents and other additive components. These additives can be added either before or after the addition of the curing agent (C) to the water-dispersible polyurethane composition (A) and to the water-dispersible acrylic resin (B). Moreover, contents of the additives may be within the range that is known to those skilled in the art.

The method of preparing the water-based intermediate coating composition of the present invention is not particularly limited, and any method known to those skilled in the art can be used. In addition, the form of the water-based intermediate coating composition of the present invention is not particularly limited as long as it is aqueous, and examples thereof include water-soluble, water-dispersible and aqueous emulsion forms.

Next, the method of forming a multilayer coating of the present invention will be described. The method of forming a multilayer coating film of the present invention is as follows: the water-based intermediate coating composition of the present invention is applied to a material onto which an electrodeposited coating film is formed; a water-based base coating and a clear coating are sequentially applied on the material through a wet-on-wet process without curing this water-based intermediate coating; thereafter, the intermediate coating, the water-based base coating and the clear coating are baked and cured at the same time; and thereby a multilayer including the intermediate coating film, the base coating film and the clear coating film is formed. Here, the wet-on-wet process means a coating method in which a plurality of coating films is stacked without being cured.

The method of applying the coatings is not particularly limited. An air electrostatic spray which is called “react gun”, a rotating spray-type electrostatic coating machine which is usually called “micro micro bell (μμ bell)”, “micro bell (μ bel)” or “metallic bell (metabell)” or the like can be used. Pre-heating is preferably performed after coating process.

In the method of forming a multilayer coating film of the present invention, an intermediate coating film and top coating film can be thermally cured at one time before applying a clear coating.

When a cationic electrodeposited coating is applied to a material to be coated, publicly-known cationic electrodeposited coatings can be used. An example of the electrodeposited coatings is a coating composition containing cationic resin and a curing agent. Examples of cationic resins include, but are not limited to, amine-modified epoxy resin series described in Japanese Patent Publication No. S54-4978, Japanese Patent Publication No. S56-34186 and the like, amine-modified polyurethanepolyol resin series described in Japanese Patent Publication No. S55-115476 and the like, amine-modified polybutadiene resin series described in Japanese Patent Publication No. S62-61077, Japanese Patent Laid-Open No. S63-86766 and the like, amine-modified acrylic resin series described in Japanese Patent Laid-Open No. S63-139909, Japanese Patent Publication No. HO1-60516 and the like, and sulfonium group-containing resin series described in Japanese Patent Laid-Open No. H06-128351 and the like. In addition to the resin series described in the gazettes, phosphonium group-containing resin series and the like can be used. Among the above-described cationic resin, amine-modified epoxy resin series are particularly preferable.

The water-based intermediate coating composition of the present invention is applied after a cationic electrodeposited coating is applied. Application of the water-based intermediate coating composition can be performed by the coating method described above. After application, the water-based intermediate coating composition is dried or heated. Thus, a dried intermediated coating film, which is not cured, can be formed. The conditions of drying and heating are not particularly limited. However, for example, drying or heating is performed under the following conditions: that the temperature is between room temperature as a lower limit of room temperature and 100° C. as an upper limit of; and that the time duration is between 30 seconds as a lower limit and 15 minutes as an upper limit.

With regard to a coating film which is formed of a water-based intermediate coating composition, the thickness thereof after having been cured is not particularly limited, and can be appropriately set depending on applications. The lower limit of the film thickness is preferably 10 μm, more preferably 15 μm. The upper limit of the film thickness is preferably 40 μm, more preferably 30 μm. If the film thickness exceeds the upper limit, disadvantageous events may occur, such as sagging at a time of coating and generation of pinholes at a time of curing. Meanwhile, if the film thickness is less than the lower limit, the resultant coating film may be deteriorated in appearance and in anti-chipping property.

Next, a water-based base coating is applied without curing the resultant intermediate coating film. Examples of the water-based base coating include, but not limited to, compositions which contains film-forming resin, curing agents, luminescent pigments, pigments such as coloring pigments and extenders, and various additives. For the film-forming resin, for example, polyester resin, acrylic resin, urethane resin, carbonate resin and epoxy resin can be used. In view of the dispersion property of a pigment and workability, combination of melamine resin and acrylic resin and/or polyester resin is preferable for the film-forming resin. The curing agents, pigments, and various additives which are used for the aforementioned intermediate coating composition can also be used. In addition, methods similar to those used in the preparation of the intermediate coating composition can be employed for the preparation of the water-based coating.

The pigment concentration (PWC) in the water-based base coating generally has a lower limit of 0.1% by weight and an upper limit of 50% by weight, more preferably a lower limit of 0.5% by weight and an upper limit of 40% by weight, and further preferably a lower limit of 1% by weight and an upper limit of 30% by weight. If the pigment concentration is less than 0.1% by weight, effects provided by a pigment can not be obtained. Meanwhile, if the concentration exceeds 50% by weight, appearance of the resulting coating film may be deteriorated.

The form of the water-based base coating is not particularly limited, and may be in any of water-soluble, water-dispersive and emulsion forms. Generally, the water-based base coating is applied so that a coating film has a thickness of 10 to 30 μm after drying and curing are performed. If the coating film has a thickness of less than 10 μm after the above drying and curing process, it is possible that a base material may be visible or that uneven coloring is caused. Meanwhile, when the film thickness exceeds 30 μm, it is possible that sagging may occur at a time of coating or that pinholes may be generated at a time of curing.

The method of applying a water-based base coating includes the aforementioned coating method. When water-based coatings are applied to automotive bodies and the like, any one of the following coating methods is preferably adopted in order to achieve better appearance: specifically, two-stage coating, which is performed by means of the above-described air electrostatic spray coating for multi-stage coating; and a coating method in which the air electrostatic spray coating and the rotating spray-type electrostatic coating is combined. The resultant base coating film provides a material to be coated with fine appearance as well as protection for coating.

Formation of a base coating film by use of a water-based coating can significantly reduce organic solvent wastes which are generated in a coating process. Accordingly, the coating process of the present invention is more preferable, from the viewpoint of friendliness to the environment.

A clear coating is further applied onto the water-based base coating. Examples of the clear coating include, but not limited to, compositions containing film-forming resin, a curing agent and other additives. Examples of the film-forming resin include, but not limited to, acrylic resin, polyester resin, epoxy resin and urethane resin. The resin is used in combination with a curing agent such as amino resin and/or isocyanate resin. From a viewpoint of transparency or acid etching resistance, it is preferable to use a combination of acrylic resin and/or polyester resin and amino resin, or acrylic resin and/or polyester resin having carboxylic acid/epoxy curing system. The form of the clear coating may be any of organic solvent type, water-based type (water-soluble, water-dispersible, emulsion), non-water dispersible type and powder type. If necessary, a curing catalyst and a surface adjusting agent and the like may be used.

Conventional methods can be employed as the methods of preparing and applying a clear coating. Depending on applications, the clear coating film has a thickness of, for example, 10 to 70 μm after a heating and curing process. If the film thickness exceeds the upper limit, disadvantageous events, such as reduction in clarity, non-uniformity and sagging, may occur. Meanwhile, if the film thickness is less than the lower limit, appearance may be deteriorated. A clear coating film obtained from a clear coating has the following effects: that, when a water-based metallic base coating which contains luminescent materials is used as the water-based base coating, by smoothing irregularities on a base coating film which are generated because of the luminescent materials, the coating film becomes lustrous; and that it protects the base coating film.

In the heating and curing process to be performed after an uncured multilayer coating film is formed through the wet-on-wet process, it is preferable that the lower and upper limits of the curing temperature be 110° C. and 180° C. respectively, but it is more preferable that the lower and upper limits be 120° C. and 160° C. respectively. Thus, a highly-crosslinked cured coating film can be obtained. If the curing temperature is lower than 110° C., curing may be insufficient. Meanwhile, if the curing temperature exceeds 180° C., the resultant coating film may be hard and brittle. The curing time is appropriately set in accordance with the above-described temperature, and is set to, for example, 10 to 60 minutes when temperature is 120° C. to 160° C.

The material to be coated by use of the method of the present invention is not particularly limited as long as it is a metal product which can be subjected to a cation electrodeposited coating process. Examples thereof include iron, copper, aluminum, tin and zinc and alloy containing these metals, as well as products plated or deposited with these metals.

### EXAMPLES

Hereinafter, the present invention will be further described in detail by way of examples. However, the present invention is not limited to the examples. In addition, unless otherwise indicated, “part” means “part by weight” in the examples.

### Preparation Example 1

### Preparation of Water-Dispersible Polyurethane Composition A-1

Here, 0.26 mole part of polycarbonatediol obtained from 1,6-hexanediol with a molecular weight of 2,000, 1.0 mole part of isophorone diisocyanate, 0.36 mole part of dimethylolpropionic acid, and N-methyl-2-pyrodidone which makes up 39% by weight of the total weight of these compounds were placed in a flask. Then, under nitrogen flow, a reaction thereof was allowed to initiate at 125° C. for 2 hours. Thereafter, 0.47 mole part of triethylamine was added to the resultant solution, followed by further mixing for 1 hour, and thus, pre-polymer was obtained. To 120 g of water, into which 0.05 g of silicone anti-foaming agent SE-21 (trade name, manufactured by Wacker Silicone Co., Ltd.) had been dissolved, 100 g of the thus obtained pre-polymer was added dropwise to this solution by spending 15 minutes. Subsequently, 2.4 g of monoethanolamine was added to the resultant solution. Furthermore, the solution was mixed at 40° C. until IR measurement determined that the absorption of light caused by isocyanate groups was disappeared. Thus, a water-dispersible polyurethane composition (A) No. 1 having a solid content of 31.5% was obtained. When the average molecular weight of the polyurethane dispersed in this composition was measured by GPS analysis under the following conditions, the average molecular weight was 22,000.

Molecular weight measurement conditions: columns; TSKgel G4000 G3000 G2000, eluant; THF, flow rate; 1.000 ml/min, detection; UV (245 nm), standards; PST

### Preparation Example 2

### Preparation of Water-Dispersible Polyurethane Composition A-2

Here, 0.26 mole part of polycarbonatediol obtained from 1,6-hexanediol with a molecular weight of 2,000, 1.0 mole part of dicyclohexylmethane-4,4′-diisocyanate, 0.36 mole part of dimethylolpropionic acid, and N-methyl-2-pyrodidone which makes up 40% by weight of the total weight of these compounds were placed in a flask. Then, under nitrogen flow, a reaction was allowed to occur at 125° C. for 2 hours. Thus, pre-polymer was obtained. To 600 g of water, where 0.25 g of the above-described silicone anti-foaming agent SE-21, 22.0 g of triethylamine, 0.315 g of ethylenediamine and 5.35 g of monoethanolamine had been dissolved, 500 g of the thus obtained pre-polymer was added dropwise to this solution by spending 15 minutes. Furthermore, the solution was mixed at 40° C. for 30 minutes until IR measurement determined that the absorption of light caused by isocyanate groups was disappeared. Thus, a water-dispersible polyurethane composition (A) No. 2 having a solid content of 32.0% was obtained. When the average molecular weight of the polyurethane dispersed in this composition was then measured as in the case of the preparation example 1, it was 30,000.

### Preparation Example 3

### Preparation of Water-Dispersible Polyurethane Composition A-3

Here, 0.26 mole part of polycarbonatediol obtained from 1,6-hexanediol with a molecular weight of 2,000, 1.0 mole part of dicyclohexylmethane-4,4′-diisocyanate, 0.36 mole part of dimethylolpropionic acid, and N-methyl-2-pyrodidone which makes up 39% by weight of the total weight of these compounds were placed in a flask. Then, under nitrogen flow, a reaction was allowed to occur at 125° C. for 2 hours. Thus, pre-polymer was obtained. To 120 g of water, where 0.05 g of the above-described silicone anti-foaming agent SE-21, 3.94 g of triethylamine, 0.31 g of ethylenediamine and 1.78 g of monoethanolamine had been dissolved, 100 g of the thus obtained pre-polymer was added dropwise to this solution by spending 15 minutes. Furthermore, the solution was mixed at 40° C. for 30 minutes until IR measurement determined that the absorption of lihgt caused by isocyanate groups was disappeared. Thus, a water-dispersible polyurethane composition (A) No. 3 having a solid content of 31.6% was obtained. When the average molecular weight of the polyurethane dispersed in this composition was then measured as in the case of the preparation example 1, it was 48,000.

### Preparation Example 4

### Preparation of Water-Dispersible Polyurethane Composition A-4

Here, 0.34 mole part of polycarbonatediol obtained from 1,6-hexanediol having a molecular weight of 1,000, 1.0 mole part of dicyclohexylmethane-4,4′-diisocyanate, 0.36 mole part of dimethylolpropionic acid, and N-methyl-2-pyrodidone which makes up 40% by weight of the total weight of these compounds were placed in a flask. Then, under nitrogen flow, a reaction was allowed to occur at 125° C. for 2 hours. Thus, pre-polymer was obtained. To 120 g of water, where 0.05 g of the above-described silicone anti-foaming agent SE-21, 5.00 g of triethylamine, 0.62 g of ethylenediamine and 2.16 g of monoethanolamine had been dissolved, 100 g of the thus obtained pre-polymer was added dropwise to this solution by spending 15 minutes. Furthermore, the solution was mixed at 40° C. for 30 minutes until IR measurement determined that the absorption of light caused by isocyanate groups was disappeared. Thus, a water-dispersible polyurethane composition (A) No. 4 having a solid content of 31.7% was obtained. When the average molecular weight of the polyurethane dispersed in this composition was then measured as in the case of the preparation example 1, it was 17,000.

### Preparation Example 5

### Preparation of Water-Dispersible Polyurethane Composition A-5

Here, 0.12 mole part of polycarbonatediol obtained from 1,6-hexanediol with a molecular weight of 1,000, 0.16 mole part of melamine, 0.27 mole part of dimethylolpropionic acid, 1.0 mole part of dicyclohexylmethane-4,4′-diisocyanate, and N-methyl-2-pyrodidone which makes up 60% by weight of the total weight of these compounds were placed in a flask. Then, under nitrogen flow, a reaction was allowed to occur at 125° C. for 2 hours. Thereafter, 0.27 mole part of trimehtylamine was added to the resultant solution, followed by further mixing for 1 hour. Thus, pre-polymer was obtained. To 117 g of water, where 0.05 g of the above-described silicone anti-foaming agent SE-21 had been dissolved, 100 g of the thus obtained pre-polymer was added dropwise to this solution by spending 15 minutes. Thereafter, 1.2 g of ethylenediamine, 1.2 g of monoehanolamine, and 1.3 g of adipic dihydrazide were added to the resultant solution. The solution was then mixed at 40° C. until IR measurement determined that the absorption of light caused by isocyanate groups was disappeared. Thus, a water-dispersible polyurethane composition (A) No. 5 with a solid content of 29.0% was obtained. When the average molecular weight of the polyurethane dispersed in this composition was then measured as in the case of the preparation example 1 with the exception that DMSO was used as a solvent, it was 200,000.

### Preparation Example 6

### Preparation of Water-Dispersible Acrylic Resin B-1

Into a reaction vessel equipped with a mixer, a thermometer, a tap funnel, a reflux condenser, a nitrogen gas transfer tube and the like, which is generally used for the preparation of an acrylic-based resin emulsion 445 parts of water and 5 parts of Neucol 293 (trade name, manufactured by Nippon Nyukazai Co., Ltd) were placed. Then, this mixture was heated to 75° C. under constant mixing. A monomer mixture which contains the below-described monomers (an acid value: 10, a hydroxyl group value: 60, and Tg: −15° C.), 240 parts of water and 30 parts of Neucol 293 was emulsified by use of a homogenizer. Under constant mixing, the monomer pre-emulsion was then added dropwise to the reaction vessel by spending 3 hours. In parallel with the addition of the monomer pre-emulsion, as a polymerization initiator, an aqueous solution which is obtained by dissolving 1 part of ammonium persulfate (APS) into 50 parts of water was added dropwise to the reaction vessel uniformly throughout the duration of the addition of the pre-emulsion. After the addition of the monomer pre-emulsion, the resultant solution was further allowed to stand at 80° C. for 1 hour for reaction, and was then cooled. Thereafter, an aqueous solution obtained by dissolving 2 parts of dimethylaminoethanol into 20 parts of water was added to the solution. Thus, an aqueous resin emulsion having a solid content of 40.0% by weight was obtained. The resultant resin emulsion was adjusted to pH 7.2 by the addition of 30% aqueous solution of dimethylaminoethanol.

(Composition of the Monomer Mixture)

| | | |
|---|---|---|
| ethyl methacrylate: | 119 | parts |
| butyl acrylate: | 231 | parts |
| styrene: | 62 | parts |
| 4-hydroxybutyl acrylate: | 80 | parts |
| methacrylic acid: | 8 | parts |
| ethylene glycol dimethacrylate: | 20 | parts |

### Preparation Examples 7 to 13

### Preparation of Water-Dispersible Acrylic Resin B-2 to B-8

Acrylic resin B-2 to B-8 were prepared as in the case of the preparation example 6, with the exception that the compositions described in the following Table 1 were adopted in place of the composition of the monomer mixture in the preparation example 6.

TABLE 1

| | Water- | Water- | Water- | Water- | Water- | Water- | Water- | Water- |
|---|---|---|---|---|---|---|---|---|
| | dispersible | dispersible | dispersible | dispersible | dispersible | dispersible | dispersible | dispersible |
| | acrylic B-1 | acrylic B-2 | acrylic B-3 | acrylic B-4 | acrylic B-5 | acrylic B-6 | acrylic B-7 | acrylic B-8 |
| MMA (Weight part) | 119 | 52 | 62 | 83 | 103 | 45 | 119 | 119 |
| BA(Weight part) | 231 | 291 | 291 | 231 | 231 | 241 | 231 | 231 |
| ST(Weight part) | 62 | 53 | 53 | 62 | 62 | 50 | 62 | 62 |
| MAA(Weight part) | 8 | 14 | 14 | 14 | 14 | 14 | 8 | 8 |
| 4HBA(Weight part) | 80 | 0 | 0 | 110 | 110 | 0 | 80 | 80 |
| FM-1(Weight part) | 0 | 90 | 90 | 0 | 0 | 0 | 0 | 0 |
| 2HEA(Weight part) | 0 | 0 | 0 | 0 | 0 | 150 | 0 | 0 |
| EGDM(Weight part) | 20 | 20 | 0 | 0 | 0 | 20 | 0 | 0 |
| KBM-502(Weight part) | 0 | 0 | 10 | 0 | 0 | 0 | 0 | 5 |
| DAAm(Weight part) | 0 | 0 | 0 | 20 | 0 | 0 | 0 | 0 |
| TACT(Weight part) | 0 | 0 | 0 | 0 | 0 | 0 | 10 | 5 |
| Acid Value (mg KOH/g) | 10 | 18 | 18 | 18 | 18 | 18 | 10 | 10 |
| Hydroxyl group Value | 60 | 40 | 40 | 82 | 82 | 139 | 60 | 60 |
| (mg KOH/g) | | | | | | | | |
| Tg(° C.) | −15 | −21 | −21 | −25 | −25 | −19 | −15 | −15 |

Abbreviations are as follows.
MMA Methyl methacrylate
BA Butyl acrylate
ST Styrene
MAA Methacrylic acid
4HBA 4-Hydroxybutyl acrylate
FM-1 Placcel FM-1 (manufactured by Daicel Chemical Industries, Ltd)
2HEA 2-Hydroxyethyl acrylate
EGDM Ethylene glycol dimethacrylate
KBM-502 Alkoxy group-containing monomer (manufactured by Shin-Etsu Chemical Co., Ltd)
DAAm Diacetone acrylamide
TACT Triallylcyanurate

It should be noted that the acid values and the hydroxyl group values described in the preparation example 6 and Table 1 are respectively calculated on the basis of the mixed amounts of the respective polymerizable unsaturated monomers contained in the monomer mixtures. In addition, the Tg values are calculated on the basis of the glass transition temperatures of the homopolymers of the respective polymerizable unsaturated monomers contained in the monomer mixtures and on the basis of the weight fractions of the respective monomers.

### Preparation Example 14

### Preparation of Coloring Pigment Paste

Here, 9.4 parts of a commercially available dispersant “Disperbyk 190” (trade name, manufactured by Byk-Chemie. An anionic/nonionic dispersant), 36.8 parts of ion-exchanged water, 34.5 parts of rutile titanium dioxide, 34.4 parts of barium sulfate, and 6 parts of talc were preliminarily mixed. Thereafter, glass bead media was added to the resultant mixture in a paint conditioner, and was then mixed and dispersed at room temperature until the particle size became 5 μm or less. Thus, a dispersant-coloring-pigment-dispersion paste was obtained.

### Preparation Example 15

### Preparation of Curing Agent-Contained Emulsion D-1

Here, 1876 parts of deionized water, 400 parts of LATEMUL PD-104(trade name, manufactured by Kao Corporation. 20% aqueous solution of reactive surfactant), and 8 parts of rongalite (sodium formaldehyde sulfoxylate) were added to a 10L stainless beaker equipped with a mixer (manufactured by Tokushu kika kogyo Co., Ltd, trade name: T.K.ROBOMICS). Then, the mixture was constantly mixed until rongalite was dissolved. While constantly mixing this mixture with the mixer at 2,000 rpm, a mixture which uniformly contains 80 parts of styrene, 227 parts of methyl methacrylate, 393 parts of methyl acrylate, 549 parts of ethyl acrylate, 246 parts of 4-hydroxybutyl acrylate, 24 parts of methacrylic acid, 80 parts of ethylene glycol dimethyacrylate and 667 parts of CYMEL 211 (trade name, manufactured by Nihon Cytec Industries Inc. Solid content=80% by weight, methoxy/butoxy ratio=65/35, water-compatibility=8 ml/g, xylene-compatibility>100 ml/g) was gradually added to the mixture. Thus, a primary emulsified matter was obtained. The primary emulsified matter was then emulsified by using the mixer at 12,000 rpm for 20 minutes while being cooled by ice water. Subsequently, the particle size thereof was measured using ELS-800 (trade name, manufactured by Otsuka electronics Co., Ltd). The particle size of the resultant pre-emulsion was 154 nm.

Next, 758 parts of the above-described pre-emulsion was placed into a 5L vertically-oriented flask equipped with a mixer, a thermometer, condenser, nitrogen gas transfer tube and a water bath. The pre-emulsion was then heated to 40° C. under constant mixing at 150 rpm. Then, 15 parts of an initiator solution, in which 80 parts of deionized water and 8 parts of KAYABUTHYL H-70 (trade name, manufactured by KAYAKU AKUZO Co., LTd, 70% aqueous solution of t-butyl hydrooxide) are mixed, was added to the resultant mixture, and polymerization was initiated. The mixture was retained at 40° C. for 10 minutes. Thereafter, the remaining 3792 parts of the pre-emulsion and 73 parts of the initiator solution were added dropwise to the mixture simultaneously by spending 3 hours. After the addition of the pre-emulsion and initiator solution, the mixture was retained at 40° C. for 2 hours. To the resultant mixture, 51 parts of 25% aqueous solution of dimethylaminoethanol (DMEA) was added dropwise by spending 30 minutes. After the addition of DMEA solution, the mixture was retained 40° C. for 1 hour and was then cooled to room temperature. Thereafter, the mixture was filtrated through 400 mesh, whereby an emulsion was separated. The solid content, pH value and particle size of the resultant emulsion were 45.5%, 8.6 and 256 nm, respectively.

### Preparation Examples 16 to 20

### Preparation of Curing Agent-Contained Emulsions D-2 to D-6

Redox polymerization was performed as in the case of the preparation example 15, with the exception that the amount of deionized water, the composition and amount of monomers, the type and amount of melamine, and the amount of neutralization amines, which are employed for the preparation of the pre-emulsion of the preparation example 15, were altered as described in the following Table 2. Thus, emulsions were obtained that have characteristics shown in Table 2.

TABLE 2

| | | Curing agent-contained emulsions *Note⁵ | | | | |
|---|---|---|---|---|---|---|
| Materials | Characteristics | D-2 | D-3 | D-4 | D-5 | D-6 |
| Deionized water for preparation | | 1876 | 1654 | 1876 | 1876 | 1876 |
| of pre-emulsion (Weight part) | | | | | | |
| LATEMUL PD-104 (Weight part) | | 400 | 400 | 400 | 400 | 400 |
| Rongalite (Weight part) | | 8 | 8 | 8 | 8 | 8 |
| St (Weight part) | | 80 | 80 | 80 | 80 | 80 |
| MMA (Weight part) | | 227 | 227 | 209 | 39 | 62 |
| MA (Weight part) | | 393 | 393 | 367 | 478 | |
| EA (Weight part) | | 549 | 549 | 622 | 732 | |
| nBA (Weight part) | | | | | | 228 |
| nBMA (Weight part) | | | | | | 879 |
| 4HBA(Weight part) | | 246 | 246 | 205 | 246 | 246 |
| MAA (Weight part) | | 24 | 24 | 37 | 24 | 24 |
| EGDM (Weight part) | | 80 | 80 | 80 | | 80 |
| C-211 (Weight part) *Note¹ | | | | 667 | | |
| C-204 (Weight part) *Note² | | 667 | | | 667 | 667 |
| SB-13-548 (Weight part) *Note³ | | | 889 | | | |
| Deionized water for initiator | | 80 | 80 | 80 | 80 | 80 |
| (Weight part) | | | | | | |
| KAYABUTYL H-70 (Weight part) | | 8 | 8 | 8 | 8 | 8 |
| 25% Aqueous solution of DMEA | | 51 | 51 | 76 | 51 | 51 |
| (Weight part) | | | | | | |
| Emulsion designing parameters | Acid value (mg KOH/g) | 10 | 10 | 15 | 10 | 10 |
| | Hydroxyl group value (mg KOH/g) | 60 | 60 | 50 | 60 | 60 |
| | Glass transition temperature (° C.) | 5 | 5 | 5 | −10 | 5 |
| | Solubility parameter | 11.2 | 11.2 | 11.2 | 11.2 | 10.2 |
| Emulsion characteristics | Concentration of solid content (%) | 47.8 | 48.3 | 45.7 | 48.3 | 47.5 |
| | pH | 8.4 | 8.2 | 8.1 | 8.2 | 8.3 |
| | Average particle diameter | 239 | 229 | 260 | 210 | 240 |
| | (nm) *Note⁴ | | | | | |

*Note¹:
CYMEL 211 (manufactured by Nihon Cytec Industries Inc., solid content = 80% by weight, methoxy/butoxy
raio = 65/35, water-compatibility = 8 ml/g, xylene-compatibility > 100 ml/g)
*Note²:
CYMEL 204 (manufactured by Nihon Cytec Industries Inc., solid content = 80% by weight, methoxy/butoxy
raio = 30/70, water-compatibility = 4 ml/g, xylene-compatibility > 100 ml/g)
*Note³:
Super Beckamine 13-548 (manufactured by Dainippon Ink and Chemicals, solid content = 60% by weight,
methoxy/butoxy raio = 0/100, water-compatibility = 3 ml/g, xylene-compatibility > 100 ml/g)
*Note⁴:
measured by ELS-800 manufactured by Otsuka electronics Co., Ltd)
*Note⁵:
Blanks in Table represent 0 (zero)
Abbreviations are as follows:
St: Styrene
EA: Ethyl acrylate
4HBA: 4-hydoroxybutyl acrylate
MMA: Methyl methacrylate
nBA: n-butyl acrylate
MAA: Methacrylic acid
MA: Methyl acrylate
nBMA: n-butyl methacrylate
EDGM: Ethylene glycol dimethacrylate

### Example 1

(Preparation of a Water-Based Intermediate Coating)

Here, 60.3 parts (solid content: 37.3 parts) of the coloring pigment dispersion paste obtained in the preparation example 14, 49.8 parts (solid content: 15.7 parts) of the water-dispersible polyurethane composition A-1 and 78.3 parts (solid content: 31.3 parts) of the water-dispersible acrylic resin B-1 were mixed. To the mixture, 17.4 parts (solid content: 5.7 parts) of CYMEL 327 (trade name, manufactured by Nihon Cytec Industries Inc. Melamine resin) was added. Thereafter, 1 part of Adecanol UH-814N (trade name, manufactured by Asahi Denka Co., Ltd, an urethane association type thickener) was added to the mixture, followed by constant mixing. Thus, a water-based intermediate coating was obtained.

(Formation of a Multilayer Coating Film)

Powertop U-50 (trade name, a cationic electrodeposited coating manufactured by Nippon Paint Co., Ltd.) was electrodeposited on a dull steel plate which had been treated with zinc phosphate treatment, so that a coating film has a thickness of 20 μm after having been dried. The resultant plate was heated and hardened at 160° C. for 30 minutes and then cooled, whereby a steel plate substrate was prepared.

The water-based intermediate coating was applied on the resultant substrate to have a thickness of 20 μm by air spray coating, followed by pre-heating at 80° C. for 5 minutes. Thereafter, Aqualex AR-2000 silver metallic (trade name, a water-based metallic base coating manufactured by Nippon Paint Co., Ltd.) was applied to the substrate to have a thickness of 10 μm by air spray coating, followed by pre-heating at 80° C. for 3 minutes. Further, MACFLOW O-1800W-2 clear (trade name, an acid epoxy curing-type clear coating manufactured by Nippon Paint Co., Ltd.) as a clear coating was applied to the substrate to have a thickness of 35 μm by air spray coating, followed by heating and curing at 140° C. for 30 minutes to obtain a test specimen having a multilayer coating film. Separately, as a test specimen for recoat adhesion property evaluation, a test specimen was also obtained by curing the above-described substrate at 160° C. for 30 minutes. Note that, the water-based intermediate coating, water-based metallic base coating and clear coating were diluted in accordance with the following conditions and were applied for coating.

(Water-Based Intermediate Coating)

thinner: ion-exchanged water

40 seconds/No. 4 Ford cup/20° C.

(Water-Based Metallic Base Coating)

thinner: ion-exchanged water

45 seconds/No. 4 Ford cup/20° C.

(Clear Coating)

thinner: a mixture solvent where ethoxyethyl propionate (EEP)/S-150 (trade name, an aromatic hydrocarbon solvent,

manufactured by Exxon mobile Corporation)=1/1 (weight ratio) 30 seconds/No. 4 Ford cup/20° C. (Evaluation of Performance)

The resultant test specimens having multilayer coating films were evaluated as follows.

(i) Paint-Removability of Spray Guns

By using a metallic bell manufactured by ABB Corporation, an intermediate coating was continuously applied for 1 minute under the following conditions: applied voltage=−90 kV; rotation speed=25000 rpm; shaping air flowing rate=520 NL; and discharge amount=200 cc/min. Thereafter, while allowing the bell to keep rotating, cleaning thinner was applied to the inside of the bell for cleaning. Here, by visual inspection, the degree of removal of the water-based intermediate coating attached to the inside of the bell was evaluated on the basis of the below-described criteria.

A; No coating is remained inside the bell and in the outlets.

B; No coating is remained inside the bell and a trace amount of coating is remained in the outlets.

B-; No coating is remained inside the bell and a slight amount of coating is remained in the outlets. However, there is no problem in coating processes.

C; Small amount of coating is remained inside the bell and in the outlets.

D; Substantial amount of coating is remained inside the bell and in the discharge ports.

(ii) Property of Removing the Attached Coating

The water-based intermediate coating was applied to a tin plate so that the water-based intermediate coating has a thickness of around 20 μm after having been dried. Subsequently, the resultant tin plate was allowed to stand at room temperature for drying, whereby an uncured coating film was formed. The test specimens thus obtained were dipped in a container filled with cleaning thinner and were sonicated at room temperature for 1 minute. Immediately after having been picked up the test specimens, the test specimens were washed with water under the shower. Subsequently, the degree of removal of the coating was observed.

A; The uncured coating film is completely removed.

B; A trace amount of the uncured coating film is remained.

BC; 90% or more of the uncured coating film is removed.

C; About 50% of the uncured coating film is removed.

D; Little amount of coating is removed.

Note that, the composition of the cleaning thinner is: deionized water/butyl cellosolve/dimethylethanolamine 84.5/15/0.5 (weight ratio)

(iii) Appearance of a Coating Film

By visual observation, the qualities of the test specimens having multilayer coating films were evaluated in terms of appearance.

(iv) Anti-Chipping Property

By use of a gravel chipping test instrument (manufactured by Suga Test Instruments Co., Ltd), 300 hundred pieces of crushed stones having a particle size ranging from 5 to 2.5 mm were crushed against the multilayer coating films of the test specimens under the following conditions: distance=35 cm; air pressure=3.0 kgf/cm²; and angle=45°. After the test specimens were washed with water and dried, peeling test was performed by use of gummed tapes for industrial purposes (manufactured by NICHIBAN Co., Ltd). Thereafter, the degree of peeling of the coating film was visually evaluated on the basis of the below-mentioned criteria.

A; Little film peeling

B; Small peeling area with a low frequency

B-; Small peeling area with a slightly high frequency

D; Large peeling area

(V) Water Resistance

The test specimens having multilayer coating films were dipped in 40° C. water for 10 days. After 1 hour following the washing of the test specimens, appearance of each of the test specimens was visually evaluated on the basis of the below-described criteria.

A; No change

B; The portion which has been dipped in the hot water is slightly expanded. However, it returns to original shape immediately.

B-; The portion which has been dipped in the hot water is slightly expanded and is discolored. However, it returns to original shape and color immediately.

BC; The portion which has been dipped in the hot water is somewhat expanded and is discolored. However, it returns to original shape and color immediately.

D; The portion which has been dipped in the hot water is largely expanded and is discolored, and it takes a certain duration to return to original shape and color.

(iv) Recoat Adhesion Property

On the test specimens having multilayer coating films, multilayer coating films were further formed by the similar method. Thus, recoat-combined coating films were produced. In accordance with JIS K5600, 25 pieces of lattice-shaped patterns were then formed on each of the test specimens at 2 mm intervals by use of a cutter knife. Then, 75 mm length transparent adhesive tapes were adhered to each of the lattice-shaped portions, and were then separated at an angle of about 60°.

The recoat adhesion property was evaluated on the basis of the recoat adhesion properties A and B. That is, the recoat adhesion property A is evaluated in a case where the baking was performed under condition of 140° C. heating for 30 minutes is adopted at the time of forming the first and second combined-multilayer coating films. Meanwhile, the recoat adhesion property B is evaluated in a case where the baking was performed with 160° C. heating for 30 minutes is adopted at the time of forming the first combined-multilayer coating film, and baking was performed with 130° C. heating for 30 minutes is adopted at the time of forming the second combined-multilayer coating film.

A; 100% adhesion is observed

C; Some lattice patterns are seen for which edge portions are pealed. However, in any lattice patterns, the peeling are as equals to 50% or less of the total area.

D; one or more lattice patterns are seen for which the pealed areas equal to 50% or more of the total area.

Table 4 shows the results of the performance evaluations.

### Examples 2 to 15 and Comparative Examples 1 to 2

In examples 2 to 15 and comparative examples 1 to 2, water-based intermediate coatings were prepared as in the case of example 1, with the exceptions that the mixed amounts of the water-dispersible polyurethane composition, the water-dispersible acrylic resin described in Table 1 and the curing agent-contained emulsions described in Table 2 were altered to those described in the following Table 3 and that the type and mixing amount of the curing agent was changed to those described in Table 3. Then, coatings were applied to form multilayer coating films, followed by performance evaluations.

Here, the modified-carbodiimide compound used as the curing agent in example 4 was prepared as follows: 700 parts of 4,4′-dicyclohexylmethane diisocyanate was allowed to reacted with 14 parts of a catalyst for cabodiimide formation (3-methyl-1-phenyl-2-phospholene-1-oxide) at 180° C. for 16 hours; thus, isocyanate-terminated 4,4′-dicyclohexylmethane diisocyanate (content of carbodiimide group: 4 equivalent weight) was obtained; next, 226.8 parts of the thus obtained carbodiimide was dissolved into 106.7 parts of N-methylpyrolidone at 90° C.; next, 200 parts of polypropylene glycol (a number average molecular weight: 2,000) was stirred at 40° C. for 10 minutes; thereafter, 0.16 part of dibutyl tin dilaurate was added to the mixture; and the mixture was again heated to 90° C., followed by reaction for 3 hours; furthermore, 96.4 parts of poly(oxyethylene)mono-2-ethylhexylether having 8 oxyethylene units was added to the mixture, followed by reaction at 100° C. for 5 hours; and thereafter, 678.1 parts of ion-exchanged water was added to the mixture at 50° C., whereby a hydrophilic modified-carbodiimide compound dispersed in water, the resin solid content of which is 40%, was obtained.

In addition, the water-dispersible acrylic resin B-4 used 20 parts of diacetoneacrylamide as a carbonyl group-containing monomer. Accordingly, 10 parts of adipic dihydrazide was added after polymerization.

TABLE 3

| Formulation | Mixed amount (Weight part) *Note¹ | | | | | | | | |
|---|---|---|---|---|---|---|---|---|---|
| ingredients | Example 1 | Example 2 | Example 3 | Example 4 | Example 5 | Example 6 | Example 7 | Example 8 | Example 9 |
| Pigment dispersion | 60.3(37.3) | 60.3(37.3) | 60.3(37.3) | 60.3(37.3) | 60.3(37.3) | 60.3(37.3) | 60.3(37.3) | 60.3(37.3) | 60.3(37.3) |
| passt | | | | | | | | | |
| Water-dispersible | 49.8(15.7) | | | | 79.7(25.1) | 49.8(15.7) | 49.8(15.7) | 49.8(15.7) | |
| polyurethane | | | | | | | | | |
| composition A-1 | | | | | | | | | |
| Water-dispersible | | 49.1(15.7) | | | | | | | 27.6(8.0) |
| polyurethane | | | | | | | | | |
| composition A-2 | | | | | | | | | |
| Water-dispersible | | | 49.7(15.7) | | | | | | |
| polyurethane | | | | | | | | | |
| composition A-3 | | | | | | | | | |
| Water-dispersible | | | | 49.5(15.7) | | | | | |
| polyurethane | | | | | | | | | |
| composition A-4 | | | | | | | | | |
| Water-dispersible | | | | | | | | | |
| polyurethane | | | | | | | | | |
| composition A-5 | | | | | | | | | |
| ADEKA BONTIGHTER | | | | | | | | | |
| HUX-232 | | | | | | | | | |
| Water-dispersible | 78.3(31.3) | 87.0(34.8) | | | 25.0(10.0) | | | 30.0(12.0) | |
| acrylic resin B-1 | | | | | | | | | |
| Water-dispersible | | | 107.1(42.9) | 89.9(36.0) | | | | | 60.3(24.2) |
| acrylic resin B-2 | | | | | | | | | |
| Water-dispersible | | | | | | | | | |
| acrylic resin B-3 | | | | | | | | | |
| Water-dispersible | | | | | | | | | |
| acrylic resin B-4 | | | | | | | | | |
| Water-dispersible | | | | | | 78.1(31.3) | | | |
| acrylic resin B-5 | | | | | | | | | |
| Water-dispersible | | | | | | | 78.1(31.3) | | |
| acrylic resin B-6 | | | | | | | | | |
| Water-dispersible | | | | | | | | | |
| acrylic resin B-7 | | | | | | | | | |
| Water-dispersible | | | | | | | | | |
| acrylic resin B-8 | | | | | | | | | |
| Curing | | | | | | | | 65.9(30.0) | |
| agent-contained | | | | | | | | | |
| emulsion D-1 | | | | | | | | | |
| Curing | | | | | | | | | 50.2(24.0) |
| agent-contained | | | | | | | | | |
| emulsion D-2 | | | | | | | | | |
| Curing | | | | | | | | | |
| agent-contained | | | | | | | | | |
| emulsion D-3 | | | | | | | | | |
| Curing | | | | | | | | | |
| agent-contained | | | | | | | | | |
| emulsion D-4 | | | | | | | | | |
| Curing | | | | | | | | | |
| agent-contained | | | | | | | | | |
| emulsion D-5 | | | | | | | | | |
| Curing | | | | | | | | | |
| agent-contained | | | | | | | | | |
| emulsion D-6 | | | | | | | | | |
| CYMEL 327 | 17.4(15.7) | | | | 30.7(27.6) | 17.4(15.7) | 17.4(15.7) | 5.6(5.0) | 7.2(6.5) |
| Bathydur LS-2186 | | 18.2(12.2) | | | | | | | |
| EPOCROS WS-500 | | | 10.2(4.1) | | | | | | |
| Modified- | | | | 27.5(11.0) | | | | | |
| carbodiimide | | | | | | | | | |
| compound | | | | | | | | | |
| ADEKANOL UH814N | 1.0 | 1.0 | 1.0 | 1.0 | 1.0 | 1.0 | 1.0 | 1.0 | 1.0 |

| | Mixed amount (Weight part) *Note¹ | | | | | | | |
|---|---|---|---|---|---|---|---|---|
| Formulation | | | | | | | Comparative | Comparative |
| ingredients | Example 10 | Example 11 | Example 12 | Example 13 | Example 14 | Example 15 | example 1 | example 2 |
| Pigment dispersion | 60.3(37.3) | 60.3(37.3) | 60.3(37.3) | 60.3(37.3) | 60.3(37.3) | 60.3(37.3) | 60.3(37.3) | 60.3(37.3) |
| passt | | | | | | | | |
| Water-dispersible | | | | 49.8(15.7) | 49.8(15.7) | 49.8(15.7) | | |
| polyurethane | | | | | | | | |
| composition A-1 | | | | | | | | |
| Water-dispersible | | | | | | | | |
| polyurethane | | | | | | | | |
| composition A-2 | | | | | | | | |
| Water-dispersible | 53.6(17.0) | | | | | | | |
| polyurethane | | | | | | | | |
| composition A-3 | | | | | | | | |
| Water-dispersible | | 64.7(20.5) | | | | | | |
| polyurethane | | | | | | | | |
| composition A-4 | | | | | | | | |
| Water-dispersible | | | 17.2(5.0) | | | | | |
| polyurethane | | | | | | | | |
| composition A-5 | | | | | | | | |
| ADEKA BONTIGHTER | | | | | | | | 52.3(15.7) |
| HUX-232 | | | | | | | | |
| Water-dispersible | | | 38.0(23.2) | 30.0(12.0) | | | 117.5(47.0) | 78.3(31.3) |
| acrylic resin B-1 | | | | | | | | |
| Water-dispersible | | | | | | | | |
| acrylic resin B-2 | | | | | | | | |
| Water-dispersible | 45.3(18.2) | | | | | | | |
| acrylic resin B-3 | | | | | | | | |
| Water-dispersible | | 51.1(20.7) | | | | | | |
| acrylic resin B-4 | | | | | | | | |
| Water-dispersible | | | | | | | | |
| acrylic resin B-5 | | | | | | | | |
| Water-dispersible | | | | | | | | |
| acrylic resin B-6 | | | | | | | | |
| Water-dispersible | | | | | 30.0(12.0) | | | |
| acrylic resin B-7 | | | | | | | | |
| Water-dispersible | | | | | | 30.0(12.0) | | |
| acrylic resin B-8 | | | | | | | | |
| Curing | | | | | 65.9(30.0) | 65.9(30.0) | | |
| agent-contained | | | | | | | | |
| emulsion D-1 | | | | | | | | |
| Curing | | | | | | | | |
| agent-contained | | | | | | | | |
| emulsion D-2 | | | | | | | | |
| Curing | 41.4(20.0) | | | | | | | |
| agent-contained | | | | | | | | |
| emulsion D-3 | | | | | | | | |
| Curing | | 26.3(12.0) | | | | | | |
| agent-contained | | | | | | | | |
| emulsion D-4 | | | | | | | | |
| Curing | | | 74.5(36.0) | | | | | |
| agent-contained | | | | | | | | |
| emulsion D-5 | | | | | | | | |
| Curing | | | | 63.2(30.0) | | | | |
| agent-contained | | | | | | | | |
| emulsion D-6 | | | | | | | | |
| CYMEL 327 | 8.3(7.5) | 10.6(9.5) | 3.9(3.5) | | 5.6(5.0) | 5.6(5.0) | 17.4(15.7) | 17.4(15.7) |
| Bathydur LS-2186 | | | | 7.5(5.0) | | | | |
| EPOCROS WS-500 | | | | | | | | |
| Modified- | | | | | | | | |
| carbodiimide | | | | | | | | |
| compound | | | | | | | | |
| ADEKANOL UH814N | 1.0 | 1.0 | 1.0 | 1.0 | 1.0 | 1.0 | 1.0 | 1.0 |

*Note¹:
Numbers in parentheses are amounts of solid contents, and blanks represent 0 (zero)
ADEKA BONTIGHTER HUX-232: Aqueous ester urethane resin (manufactured by Asahi Denka Co., Ltd, solid content = 30%, trade name)
Bathydur LS-2186: block isocyanate (manufactured by Sumika Bayer Co., Ltd, solid content = 67%, NCO % solid = 10.7, trade name)
EPOCROS WS-500: oxazoline group-containing acrylic resin copolymer (manufactured by NIPPON SHOKUBAI Co., Ltd, solid content = 40%, oxazoline equivalent amount/solid = 220, trade name)

TABLE 4

| Formulation | | | | | | | | | |
|---|---|---|---|---|---|---|---|---|---|
| ingredients | Example 1 | Example 2 | Example 3 | Example 4 | Example 5 | Example 6 | Example 7 | Example 8 | Example 9 |
| Paint-removability | B | B | B | B | B− | B− | B | A | A |
| of spray guns | | | | | | | | | |
| Removing property | B | B | B | B | BC | BC | B | A | A |
| of attached coating | | | | | | | | | |
| Appearance of | Excellent | Excellent | Excellent | Excellent | Excellent | Excellent | Excellent | Excellent | Excellent |
| coating film | | | | | | | | | |
| Anti-chipping | B− | B− | B− | B− | A | B− | B− | B | B |
| property | | | | | | | | | |
| Water resistance | B− | B− | B− | B− | A | B− | BC | B | B |
| Recoat adhesion | B | — | — | — | — | — | — | B | — |
| property A | | | | | | | | | |
| Recoat adhesion | C | — | — | — | — | — | — | B | — |
| property B | | | | | | | | | |

| Formulation | | | | | | | Comparative | Comparative |
|---|---|---|---|---|---|---|---|---|
| ingredients | Example 10 | Example 11 | Example 12 | Example 13 | Example 14 | Example 15 | example 1 | example 2 |
| Paint-removability | A | A | A | A | A | A | B | D |
| of spray guns | | | | | | | | |
| Removing property | A | A | A | A | A | A | BC | D |
| of attached coating | | | | | | | | |
| Appearance of | Excellent | Excellent | Excellent | Excellent | Excellent | Excellent | Excellent | Excellent |
| coating film | | | | | | | | |
| Anti-chipping | B | B | B | B | A | A | D | B |
| property | | | | | | | | |
| Water resistance | B | B | B | B | A | A | D | B |
| Recoat adhesion | — | — | — | — | B | B | — | — |
| property A | | | | | | | | |
| Recoat adhesion | — | — | — | — | B | B | — | — |
| property B | | | | | | | | |

As can be seen from the results shown in Table 4, excellent paint-removability was provided for spray guns and attached coatings were effectively removed when the water-based intermediate coatings prepared in examples 1 to 15 are used. The test specimens prepared in examples 1 to 15, having multilayer coating films, exhibited fine appearance, as well as were excellent in anti-chipping property and water resistance In addition, the test specimen prepared in example 8, which has a multilayer coating film and was produced by use of a curing agent-contained emulsion, exhibited better recoat adhesion property than that prepared in example 1 which does not include a curing agent-contained emulsion.

### INDUSTRIAL APPLICABILITY

When the water-based intermediate coating composition of the present invention is used, excellent paint-removability is provided for spray guns and the like, and attached coatings are effectively removed. For this reason, cleaning time can be reduced in coating lines. Moreover, when the method of forming a multilayer coating film, which uses three-coat one-bake wet-on-wet method of the present invention, is adopted, it is made possible to advantageously achieve reduction in coating steps, cost, and load on the environment. Accordingly, the present invention can be suitably adopted to vehicle coatings such as automotive coatings.

1. A water-based intermediate coating composition, comprising a water-dispersible polyurethane composition (A) which is obtained from:
a polyisocyanate component (a1) containing diisocyanate as an essential component;
a polyol component (a2) containing polycarbonatediol with an average molecular weight of 500 to 5,000 and carboxyl group-containing diol as essential components;
an amine component (a3) containing a monoamine compound as an essential component;
a carboxyl group-neutralizing component (a4); and
water (a5).

2. The water-based intermediate coating composition according to claim 1,
wherein the polyisocyanate component (a1) further comprises polyisocyanate other than the diisocyanate as an arbitrary component.

3. The water-based intermediate coating composition according to claim 1,
wherein the polyol component (a2) further comprises polyol other than the polycarbonatediol and the carboxy group-containing diol as an arbitrary component.

4. The water-based intermediate coating composition according to claim 1,
wherein the amine component (a3) further comprises a diamine compound as an arbitrary component.

5. The water-based intermediate coating composition according to claim 1, further comprising:
a water-dispersible acrylic resin (B) and a curing agent (C) together with the water-dispersible polyurethane composition (A),
wherein the water-dispersible acrylic resin (B) is obtained by emulsion-polymerizing a monomer mixture which contains:
at least one monomer (b1) selected from (meth)acrylic acid alkyl esters;
an acid group-containing polymerizable unsaturated monomer (b2);
a hydroxyl group-containing polymerizable unsaturated monomer (b3); and
a crosslinkable monomer (b4),
the monomer mixture showing a glass transition temperature of −50° C. to 20° C., an acid value of 2 to 60 mg KOH/g, and a hydroxyl group value of 10 to 120 mg KOH/g.

6. The water-based intermediate coating composition according to claim 5,
wherein the monomer (b1) further comprises at least one monomer selected from the group consisting of styrene-based monomers, (meth)acrylonitrile and (meth)acrylamide.

7. The water-based intermediate coating composition according to claim 5,
wherein, with respect to total resin solid contents of the water-dispersible polyurethane composition (A), the water-dispersible acrylic resin (B) and the curing agent (C), the solid content of the water-dispersible polyurethane composition (A) makes up 5 to 35% by weight, the solid content of the water-dispersible acrylic resin (B) makes up 15 to 90% by weight, and the solid content of the curing agent (C) makes up 5 to 50% by weight.

8. The water-based intermediate coating composition according to claim 1,
wherein, with respect to the water-dispersible polyurethane composition (A), the sum of the number of moles of hydroxyl groups in the polyol component (a2) and the number of moles of amino groups in the amine component (a3) is 0.50 to 2.0 times the number of moles of isocyanate groups in the polyisocyanate component (a1).

9. The water-based intermediate coating composition according to claim 1,
wherein the amine component (a3) of the water-dispersible polyurethane composition (A) includes a monoamine compound and a diamine compound.

10. The water-based intermediate coating composition according to claim 9,
wherein a diamine compound contained in the amine component (a3) of the water-dispersible polyurethane composition (A) makes up 5 to 99 mol % of the total amount of the amine component (a3).

11. The water-based intermediate coating composition according to claim 1,
wherein a monoamine compound contained in the amine component (a3) of the water-dispersible polyurethane composition A is an alkanolamine.

12. The water-based intermediate coating composition according to claim 5,
wherein the crosslinkable monomer component (b4) of the water-dispersible acrylic resin (B) contains at least one crosslinkable monomer selected from the group consisting of carbonyl group-containing polymerizable unsaturated monomers, hydrolysis polymerizable silyl group-containing monomers and multifunctional vinyl monomers.

13. The water-based intermediate coating composition according to claim 5, further comprising at least a carbonyl group-containing polymerizable unsaturated monomer as the crosslinkable monomer component (b4) of the water-dispersible acrylic resin (B), and a hydrazine compound as a crosslinking aid.

14. The water-based intermediate coating composition according to claim 5,
wherein, in the water-dispersible acrylic resin (B), 0.5 to 10 weight parts of a crosslinkable monomer component (b4) is used for 100 weight parts of the total weight of the other monomer components (b1), (b2) and (b3).

15. The water-based intermediate coating composition according to claim 5,
wherein the curing agent (C) contains at least one curing agent selected from the group consisting of melamine resin, isocyanate resin, oxazoline-based compounds and carbodiimide-based compounds.

16. The water-based intermediate coating composition according to claim 5, further comprising a curing agent-contained emulsion (D),
wherein the curing agent-contained emulsion (D) is obtained by, under the presence of a curing agent (C′), emulsion-polymerizing a monomer mixture which contains:
a polymerizable unsaturated monomer (d1);
an acid group-containing polymerizable unsaturated monomer (d2); and
a hydroxyl group-containing polymerizable unsaturated monomer (d3),
the monomer mixture showing a glass transition temperature of −30° C. to 30° C., an acid value of 5 to 15 mg KOH/g, and a hydroxyl group value of 30 to 100 mg KOH/g.

17. The water-based intermediate coating composition according to claim 16,
wherein the curing agent (C′) is at least one selected from the group consisting of melamine resin, isocyanate resin, oxazline-based compounds and carbodiimide-based compounds.

18. The water-based intermediate coating composition according to claim 16,
wherein the curing agent (C′) is melamine resin which has a methoxy group and a butoxy group, and
the methoxy/butoxy ratio is in a range of 70/30 to 0/100 and water-compatibility thereof is 10 ml/g or less.

19. The water-based intermediate coating composition according to claim 16,
wherein the curing agent-contained emulsion (D) is obtained by further mixing a polymerizable monomer (d4) having at least two radically polymerizable unsaturated groups in a molecule, with the monomers (d1) to (d3), so that the polymerizable monomer (d4) constitutes 1 to 15% by weight of the total weight of monomers (d1) to (d4), and by subjecting a resultant mixture to emulsion polymerization.

20. A method of forming a multilayer coating film, comprising:
applying a water-based intermediate coating composition defined in claim 1 on a material onto which an electrodeposited coating film is formed;
sequentially applying a water-based base coating and a clear coating on the material through a wet-on-wet process without curing the water-based intermediate coating; and
baking and curing the intermediate coating, the water-based base coating and the clear coating at the same time to form the multilayer coating film including the intermediate coating film, the base coating film and the clear coating film.
